(19) United States
(12) Patent Application Publication
(10) Pub. No.: US 2014/0234959 A1
(43) Pub. Date: Aug. 21, 2014

(54) METHOD AND DEVICE FOR REMOVING PARTICLES FROM LIQUID AND PLACING THEM INTO A HOLDING DEVICE

(71) Applicants: Patricia McGrath, Cambridge, MA (US); Edward O'Lear, Cambridge, MA (US); Wen Lin Seng, Westborough, MA (US); Demian Park, Cambridge, MA (US); Brandon Stafford, Somerville, MA (US)

(72) Inventors: Patricia McGrath, Cambridge, MA (US); Edward O'Lear, Cambridge, MA (US); Wen Lin Seng, Westborough, MA (US); Demian Park, Cambridge, MA (US); Brandon Stafford, Somerville, MA (US)

(21) Appl. No.: 14/115,705

(22) PCT Filed: May 4, 2012
(86) PCT No.: PCT/US12/36501

§ 371 Date: May 12, 2014

Related U.S. Application Data
(60) Provisional application No. 61/483,134, filed on May 6, 2011.

(51) Int. Cl. G01N 1/08

(52) U.S. Cl. CPC G01N 1/08
USPC 435/325; 435/309.1

(57) ABSTRACT

Methods, devices, and systems are disclosed for collecting or gathering samples, such as zebrafish or zebrafish eggs or embryos, dispersed in a liquid and transferring the collected or gathered samples into discrete receptacles of a holding fixture (e.g. the wells of a multi-well plate, a Petri dish, or any other suitable fixture having one or more receptacles). A method includes drawing some of the liquid through a plurality of openings in a retention structure so as to draw at least some of the samples into contact with associated openings, retaining the samples in contact with the retention structure adjacent to the associated openings using differential pressure, moving at least one of the retention structure or a holding fixture relative to the other while the samples are retained adjacent the associated openings, and ejecting samples from the retention structure into associated discrete receptacles of the holding fixture.

### RELATED APPLICATION

This application claims the benefit of U.S. Provisional Application No. 61/483,134, filed on May 6, 2011.

The entire teachings of the above application are incorporated herein by reference.

### BACKGROUND OF THE INVENTION

The present invention relates generally to collecting or gathering samples dispersed in a liquid and placing the samples (e.g., biological samples, samples of particulate mass) into discrete receptacles of a holding fixture (e.g., the wells of a multi-well plate), and more particularly to methods, devices, and systems for accomplishing the same. Such methods, devices, and systems may be particularly beneficial when used to collect or gather zebrafish or zebrafish eggs for use, for example, in medical research, in fisheries, and by breeders.

For example, in medical research, searches for target-specific therapeutic and prophylactic compounds that have the ability to enhance or inhibit angiogenesis activity, that enhance or inhibit cell death activity, and/or that exhibit low toxicity are often used during drug discovery and development. Angiogenesis plays an important role not only in the further development of the embryonic vasculature, but also in many post-natal processes, such as wound healing and tissue and organ regeneration. Angiogenesis has also been identified as a critical process in the growth of solid tumors. Furthermore, uncontrolled blood-cell proliferation and excessive angiogenesis have been shown to constitute significant pathogenic components in numerous diseases, including rheumatoid arthritis, atherosclerosis, diabetes mellitus, retinopathies, psoriasis, and retrolental fibroplasia.

One recent and promising approach to biological research has been to use zebrafish as a model organism. Zebrafish provide an animal model that can be used to screen and study many compounds. Many of these studies rely on collecting or gathering zebrafish or zebrafish eggs dispersed in a liquid and placing them into discrete receptacles of a holding fixture. However, at least some of the current approaches for handling zebrafish eggs are somewhat labor intensive, in at least some instances. For example, one approach for transferring zebrafish eggs is to draw a single egg into a Pasteur pipette and transfer the egg to a receptacle. Also, the transfer of zebrafish eggs may result in damage to at least some of the eggs, which may potentially reduce the utility of zebrafish as an animal model in at least some instances.

Accordingly, there is a need for cost-effective, comprehensive methods and devices that overcome at least some of the above-mentioned disadvantages of the current approaches for collecting or gathering samples, such as zebrafish eggs, dispersed in a liquid and transferring them into discrete receptacles of a holding fixture.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Methods, devices, and systems are disclosed for collecting or gathering samples, such as zebrafish or zebrafish eggs, dispersed in a liquid and transferring them into discrete receptacles of a holding fixture. The holding fixture can be a multi-well plate (also known as a microplate or a microtiter plate), a Petri dish, or any other suitable fixture having one or more receptacles. Such methods, devices, and systems can be used during biological research, during agricultural research, in fisheries, and by breeders. Such methods, devices, and systems can also be used to transfer non-biological samples dispersed in a liquid, such as samples of particulate mass.

In addition to zebrafish eggs, the disclosed methods, devices, and systems can be beneficially employed in conjunction with a variety of biological samples and/or samples of particulate mass. For example, the samples can be seeds, combinatorial beads, small particles, and eggs. The transferred samples can be at least one cell of an organism, such as a germ cell, an egg, a seed, an embryo, or an organ. For example, the transferred samples can include a germ cell of a gamete, such as an ovule comprising the germ cell of a female plant, a fertilized ovule comprising an embryo of the seed of the plant, an ovum comprising the germ cell of a female animal, a fertilized ovum comprising an embryo of the animal, or a germ cell of the male gamete. The transferred samples can include a sample useful for biomedical research such as a combinatorial bead or other small particle.

The disclosed methods and devices can be used to rapidly collect or gather zebrafish or zebrafish eggs or other samples from a first container and transfer them to one or more discrete receptacles of a holding fixture. The samples can be transferred so as to minimize trauma and maintain viability of the samples.

Thus, in one aspect, a handheld wand for removing one or more samples, such as zebrafish or zebrafish eggs, from water and placing the samples into one or more discrete receptacles of a holding fixture is disclosed. The handheld wand can have a wand head containing a plurality of manifold channels in fluid communication with a plurality of retention channels. The retention channels can each extend to an opening at the bottom face of the wand head. The handheld wand can also have a gas outlet in fluid communication with the manifold channels for applying a vacuum to the manifold channels to provide a differential pressure to capture the zebrafish eggs at the openings. Additionally, the handheld wand can have a gas inlet in fluid communication with the manifold channels for providing a gas for purging water in the manifold channels and for applying a downward force through the channels to release the zebrafish eggs from the opening.

In another aspect, a method is disclosed for removing one or more samples, such as zebrafish eggs, from water and placing them into one or more discrete receptacles of a holding fixture. The method includes drawing some of the liquid through a plurality of openings in a retention structure so as to draw at least some of the samples into contact with the openings of the retention structure, retaining the samples in contact with the openings of the retention structure using differential pressure, moving at least one of the retention structure or a holding fixture relative to the other while the samples are retained in contact with the openings of the retention structure, and releasing the samples from the retention structure into the discrete receptacles of the holding fixture. In many embodiments, moving at least one of the retention structure or a holding fixture includes extracting the retention structure from the liquid within the container prior to releasing the samples. In some embodiments, releasing the samples from the retention structure includes increasing the pressure to eject the samples from the retention structure. In additional embodiments, releasing of samples can occur over a time period within a range from about 0.1 to about 0.5 seconds.

In another aspect, a method of removing one or more zebrafish eggs from water and placing the zebrafish eggs into one or more receptacles of a holding fixture by using a handheld wand is disclosed. The method includes the steps of activating a vacuum source connected to a gas outlet, placing the wand into water containing one or more zebrafish eggs in order to draw water through the plurality of openings connected to the manifold channels such that the zebrafish eggs are captured at the openings, providing a gas source while the vacuum source remains activated to purge water in the manifold channels above the eggs while the eggs are captured at the openings, and providing a pressurized gas source through the plurality of channels to release the zebrafish eggs to a multi-well plate.

The method can include sensing when one or more of the samples, such as a zebrafish egg, is retained in contact with an opening of the retention structure. For example, one or more flow rate sensors can be used to measure the flow rate of the liquid through one or more of the openings. The measured flow rate(s) can be used to determine when one or more of the samples are retained in contact with the opening.

The number of samples dispersed in the liquid can be relatively large. For example, there can be at least 100 samples dispersed in the liquid in some instances. In other instances, there can be 300 or more samples dispersed in the liquid

The collected or gathered samples can be distributed into discrete receptacles of a holding fixture. The holding fixture can be a plurality of different types of holding fixtures having discrete receptacles. Most commonly, the holding fixture can be commercially available multi-well plates, such as 6, 12, 24, 48, 96, 384 or 1536-well plates. Thus, the discrete receptacles can be the individual wells of a multi-well plate. For example, the handheld wand can be used to place a plurality of zebrafish eggs, such as 30 zebrafish eggs, into a single well of a 6-well plate. In other instances, the handheld wand can be used to place an individual zebrafish egg into a single well of a muti-well plate, such as to place 96 zebrafish eggs individually into the wells of a 96-well plate. The holding fixture can also be a Petri dish or any other suitable fixture having one or more receptacles.

A quantity of the liquid (e.g., water) can be released with each of the samples. For example, when the holding fixture is a multi-well plate, releasing the samples and the liquid can be performed so that each of a plurality of the wells of the multi-well plate contains only one of the samples and a quantity of the liquid.

In addition to collecting or gathering zebrafish eggs, the handheld wand can be used to collect or gather other types of samples, such as seeds, beads, eggs, and/or other eggs or embryos. The following provides a non-exclusive list of possible samples. For example, the eggs can be capable of developing into an organism. The eggs can be fertilized and/or unfertilized. The samples can include invertebrate eggs and/or vertebrate eggs. The invertebrate eggs can include insect eggs such as fly eggs, worm eggs, and/or spider eggs. The worm eggs can include a phylum of Annelida, Chaetognatha, Nematoday, Nemertea, and/or Platyhelminthese. The worm eggs can include Caenorhabditis elegans eggs. The vertebrate eggs can include fish eggs and/or frog eggs. The fish eggs can include teleost eggs, zebrafish eggs, salmonid eggs, salmon eggs, salmo salar eggs, salvelinus fontinalis, salmo trutta, oncorhynchus tshawytscha, oncorhynchus keta, oncorhynchus kisutch, oncorhynchus clarki, salvelinus namaycush, oncorhynchus gorbuscha, oncorhynchus mykiss, oncorhynchus nerka, trout eggs, bass eggs, sea bass eggs, and/or gilthead sea bream eggs. The frog eggs can include wood frog eggs, western chorus frog eggs, northern spring peeper eggs, northern leopard frog eggs, pickerel frog eggs, eastern American toad eggs, eastern gray tree frog eggs, Cope's gray tree frog eggs, Blanchard's cricket frog eggs, mink frog eggs, green frog eggs, and/or bullfrog eggs.

The method can include drawing a gas through at least one manifold channel coupled to the plurality of openings to purge liquid from the at least one manifold channel while retaining the samples in contact with the openings of the retention structure. The method can include separating the liquid purged from the at least one manifold channel from the gas drawn through the at least one manifold channel. The method can include increasing the pressure in the at least one manifold channel to release the samples from the retention structure.

The openings of the wand head can be configured for registration with the discrete receptacles of a holding fixture. For example, the openings of the wand head can define a first array, and the discrete receptacles of a multi-well plate can define a second array. Either the wand head or the multi-well plate can be moved so as to bring the first array into registration with the second array.

The liquid can be drawn through each of the openings at a rate suitable for the samples being collected or gathered. For example, in some embodiments involving the collection of relatively small biological samples, the liquid is preferably drawn through each of the openings at a rate from about 1 to about 20 ml/min, and more preferably at a rate of about 2 to about 10 ml/min.

Each of a plurality of the openings can be a conically-shaped surface. And each of a plurality of the samples can be drawn into contact with an associated one of the conically-shaped surfaces.

In another aspect, a device is disclosed for collecting or gathering a plurality of samples (e.g., biological samples, samples of particulate mass) dispersed in a liquid within a container and transferring the collected or gathered samples into discrete receptacles of a holding fixture. The device includes a retention structure having a surface and a plurality of retention channels, each retention channel extending to the surface to define an opening sized to retain one of the samples using differential pressure. The device further includes a fluid pump in fluid communication with the retention channels and operable to draw some of the liquid through the retention channels in order to draw at least some of the samples into contact with the openings of the retention structure using differential pressure and in order to retain at least some of the samples in contact with the openings of the retention structure using differential pressure while the retention structure is extracted from the liquid within the container. The device is controllable to release the samples from the openings of the retention structure into discrete receptacles of a holding fixture. In many embodiments, a source of compressed gas can be coupled to the device via a gas inlet such that the compressed gas is in fluid communication with the plurality of channels and their associated openings. A flow control mechanism can control the introduction of compressed gas into the device via the plurality of channels. Introducing compressed gas into the channels via the flow control mechanism by pressing the “release” button can release the samples from the wand head.

In many embodiments, the device is operable to purge some of the liquid that was drawn through the openings while the samples are retained in contact with the device via differential pressure. For example, the device can include at least one manifold channel in fluid communication with the retention channels, a gas inlet in fluid communication with the fluid pump through the at least one manifold channel, and an inlet flow control mechanism to control flow of a gas from the gas inlet to the at least one manifold channel. The inlet flow control mechanism can be controllable to introduce the gas such that the gas is drawn into the at least one manifold channel to purge liquid from the at least one manifold channel while the samples are retained in contact with the wand head via differential pressure. The device can include at least one flow restriction in fluid communication with the at least one manifold channel and the gas inlet and disposed there between to more evenly distribute the flow of gas through the manifold channels. In some embodiments, the inlet control mechanism can be the same as the compressed gas inlet described above for releasing the samples from the wand head. Thus the primary difference between releasing the samples and purging the samples can be the flow rate of the compressed gas source. A greater flow rate for the compressed gas source can be used to release the samples, while a smaller flow rate can be used to purge the liquid. In other embodiments, pressing the “purge” button permits backfilling of the manifold channels with the surrounding air in the room.

The at least one manifold channel and the retention channels can be configured such that a quantity of liquid remains in the retention channels when liquid is purged from the at least one manifold channel. For example, the at least one manifold channel can extend in a first direction and the retention channels can extend in a second direction different from the first direction such that a quantity of liquid remains in the retention channels when liquid is purged from the at least one manifold channel. The at least one manifold channel can be shaped to remove water from within the at least one manifold channel when the gas is drawn into the at least one manifold channel. The retention channels can retain a quantity of liquid (e.g., no more than about 3.4 μL, or no more than about 1.7 μL) when liquid is purged from the at least one manifold channel.

In many embodiments, the openings of the retention structure are configured for registration with the discrete receptacles of a holding fixture. For example, the openings of the retention structure can define a first array, the discrete receptacles of the holding fixture can define a second array, and relative movement between the wand head (and hence the retention structure attached to the base of the wand) and the holding fixture can be used to bring the first array into registration with the second array.

The device can include one or more sensors to sense the presence of one or more of the samples being retained in contact with the openings of the retention structure. For example, the device can include a plurality of sensors with each of the sensors positioned to sense the presence of one of the samples being retained via an associated one of the retention channels. The sensors can include a flow rate sensor positioned to sense a change in flow rate through an associated one of the retention channels. The device can include circuitry coupled with the sensors and configured to determine when at least one of the samples is retained via an associated one of the retention channels. The device can include a display coupled with the sensors and configured to indicate which openings of the plurality of openings are retaining one of the samples.

The device can be configured with different numbers of openings. For example, the device can include from 10 to 500 openings. Alternatively, the device can be configured to have 30 openings. The device can also be configured to have the same number of openings as commercially available well plates, namely 6, 12, 24, 48, 96, 384 or 1536-well plates. The device can be configured to release a single sample into a discrete receptacle of a holding fixture. The device can be configured such that any number of samples can be released into a discrete receptacle of a holding fixture. Fox example, the device can be configured to release two, three, four, five, or more samples into each well of a 24-well plate. The device is not limited to releasing multiple samples into each well of a 24-well plate, and can be configured to release multiple samples into each well of any commercially-available multi-well plate by arranging the openings as desired. For example, the device can be configured to release 30 samples into a single well of a 6-well plate.

In many embodiments, at least one of the openings includes a conically-shaped surface flaring outward from an associated retention channel to the surface of the wand head. The conically-shaped surface can be configured to contact an outside surface of an associated one of the samples when the sample is retained.

In many embodiments, the device is configured for use in collecting or gathering and transferring particular sample(s). For example, the device can be configurable for use in collecting or gathering and transferring any one or more of the samples discussed above with regard to the related method.

A further understanding of the nature and advantages of the inventions herein can be realized by reference to the detailed description in the specification and the associated figures.

### BRIEF DESCRIPTION OF THE DRAWINGS

FIG. 1 diagrammatically illustrates an automated system for collecting or gathering samples dispersed in liquid within a container and transferring the collected or gathered samples into discrete receptacles of a holding fixture, in accordance with many embodiments.

FIG. 2 is a block diagram illustrating a method for collecting or gathering samples dispersed in a liquid and distributing the collected or gathered samples into discrete receptacles of a holding fixture, in accordance with many embodiments.

FIG. 3 diagrammatically illustrates exemplary samples retained in contact with a retention structure of a wand head via differential pressure, in accordance with many embodiments.

FIG. 4 diagrammatically illustrates the registration of a retention structure of a wand head configured to collect or gather and transfer samples with a multi-well plate, in accordance with many embodiments.

FIG. 5a is a perspective-view illustrating a wand for collecting or gathering samples dispersed in liquid and transferring the collected or gathered samples into discrete receptacles of a holding fixture, in accordance with many embodiments.

FIG. 5b is a close-up perspective-view illustrating the head portion of the wand of FIG. 5a.

FIG. 6a schematically illustrates a device for collecting or gathering samples dispersed in liquid and transferring the collected or gathered samples into discrete receptacles of a holding fixture, in accordance with many embodiments.

FIG. 6b is a schematic cross-sectional view illustrating the head portion of the device of FIG. 6a.

FIG. 7a is a bottom view illustrating a retention structure having 96 openings for collecting or gathering samples dispersed in liquid and transferring the collected or gathered samples into discrete receptacles of a holding fixture, in accordance with many embodiments.

FIG. 7b is a cross-sectional view of the retention structure of FIG. 7a.

FIG. 7c is a cross-sectional view illustrating an opening and a retention channel in the retention structure of FIGS. 7a and 7b.

FIG. 7d is a cross-sectional view illustrating the retention of an exemplary 1 mm diameter sample in contact with the retention structure of FIGS. 7a, 7b, and 7c.

FIG. 7e is a cross-sectional view illustrating the retention of an exemplary 2 mm diameter sample in contact with the retention structure of FIGS. 7a, 7b, and 7c.

FIG. 8a is a perspective view illustrating a manifold of a device for collecting or gathering samples dispersed in liquid and transferring the collected or gathered samples into discrete receptacles of a holding fixture, in accordance with some embodiments.

FIG. 8b is an end view of the manifold of FIG. 8a.

FIG. 9a is an end view of a manifold for the retention structure of FIGS. 7a to 7e, in accordance with some embodiments.

FIG. 9b is a cross-sectional view of the manifold of FIG. 9a illustrating manifold channels, in accordance with some embodiments.

FIG. 9c is a cross-sectional view of the manifold of FIG. 9a illustrating a manifold channel flow restriction disposed between an inlet chamber and a manifold channel, in accordance with some embodiments.

FIG. 9d is a cross-sectional view of the manifold of FIG. 9a illustrating the gas outlet in fluid communication with the outlet chamber, in accordance with some embodiments.

FIG. 10a is a schematic illustrating a single manifold design for a wand head having 96 openings.

FIG. 10b is a schematic illustrating a two manifold design for a wand head having 96 openings.

FIG. 10c is a schematic illustrating a four manifold design for a wand head having 96 openings.

FIG. 11 diagrammatically illustrates the use of a wand positioned to collect or gather exemplary samples dispersed in a liquid within a container, in accordance with many embodiments of the invention.

FIG. 12 illustrates exemplary samples that can be collected or gathered and transferred using methods, devices, and systems disclosed herein.

FIG. 13 is a block diagram illustrating a method for collecting or gathering fish eggs dispersed in a liquid and distributing the collected or gathered fish eggs into discrete receptacles of a holding fixture to observe their response to exposure to a test substance, in accordance with many embodiments.

FIG. 14 is graph illustrating the starting and final vacuum pressure measured in a wand head having 30 openings.

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

### DEFINITIONS

Unless defined otherwise, all technical and scientific terms used herein have the same meaning as commonly understood by those of ordinary skill in the art to which this invention belongs. The following references provide one of skill with a general definition of many of the terms used in this invention: Singleton et al., Dictionary of Microbiology And Molecular Biology (2d ed. 1994); The Cambridge Dictionary of Science and Technology (Walker ed., 1988); and Hale & Marham, The Harper Collins Dictionary of Biology (1991). As used herein, the following terms and phrases have the meanings ascribed to them unless specified otherwise. Although any methods and materials similar or equivalent to those described herein can be used in the practice or testing of the present invention, the preferred methods and materials are described. For purposes of the present invention, the following terms and phrases are intended to have the following general meanings as they are used herein:

The term “subject” as used herein includes an animal. The term “animal” as used herein includes a vertebrate animal, such as a vertebrate fish, or an invertebrate animal such as an insect or a worm. Vertebrate fish include teleosts, such as, e.g., zebrafish, medaka, Giant rerio, and puffer fish. The term “teleost” as used herein means of or belonging to the Teleostei or Teleostomi, a group consisting of numerous fishes having bony skeletons and rayed fins. Teleosts include, for example, zebrafish, medaka, Giant rerio, and puffer fish.

The term “egg” refers to both unfertilized and fertilized eggs. Thus, the term “zebrafish eggs” refers to both unfertilized zebrafish eggs and fertilized zebrafish embryos. Similar usage is intended for other species as well.

The term “embryo” or “embryonic” as used herein means an organism in the early stages of growth and differentiation, and that in higher animal forms merge into fetal stages but in lower forms terminate in commencement of larval life.

The term “holding fixture” as used herein means a multi-well plate (also known as a microplate or a microtiter plate), a Petri dish, or any other suitable fixture having one or more receptacles.

The term “larva” or “larval” as used herein means the stage of any of various animals, including invertebrate and vertebrate animals, such as vertebrate fishes (including teleosts, such as, e.g., zebrafish, medaka, Giant rerio, and puffer fish), between embryogenesis and adult.

A “physiological activity” in reference to an organism is defined herein as any normal processes, functions, or activities of a living organism.

A “prophylactic activity” is an activity of, for example, an agent, gene, nucleic acid segment, pharmaceutical, substance, compound, or composition which, when administered to a subject who does not exhibit signs or symptoms of a disease or exhibits only early signs or symptoms of a disease, diminishes, decreases, or prevents the risk in the subject of developing pathology.

A “therapeutic activity” is defined herein as any activity of e.g., an agent, gene, nucleic acid segment, pharmaceutical, therapeutic, substance, compound, or composition, which diminishes or eliminates pathological signs or symptoms when administered to a subject exhibiting the pathology. The term “therapeutically useful” in reference to an agent means that the agent is useful in diminishing, decreasing, treating, or eliminating pathological signs or symptoms of a pathology or disease.

While some aspects are described in terms of removing samples from water, it is contemplated that the water can include ions and other materials dissolved therein, and thus the water need not be pure water.

### DETAILED DESCRIPTION OF THE INVENTION

A description of example embodiments of the invention follows.

In the following description, various embodiments of the present invention will be described. For purposes of explanation, specific configurations and details are set forth in order to provide a thorough understanding of the embodiments. The present invention, however, may be practiced without the specific details. Furthermore, well-known features may be omitted or simplified in order not to obscure the embodiment being described.

Embodiments described herein are directed to methods, devices, and systems for collecting or gathering samples dispersed in a liquid and transferring the collected or gathered samples into discrete receptacles of a holding fixture. Such methods, devices, and systems have many applications, such as in medical research, in fisheries, for use by breeders, and the like. In Section I, methods, devices, and systems are described for collecting or gathering samples dispersed in a liquid and transferring the collected or gathered samples into discrete receptacles of a holding fixture. In Section II, experimental studies are described for determining device size and fluid flow parameters for collecting or gathering and transferring samples, such as zebrafish eggs, seeds, combinatorial beads, eggs, embryos and organs, for example eyes.

### I. Methods, Devices, and Systems for Collecting or Gathering and Transferring Samples

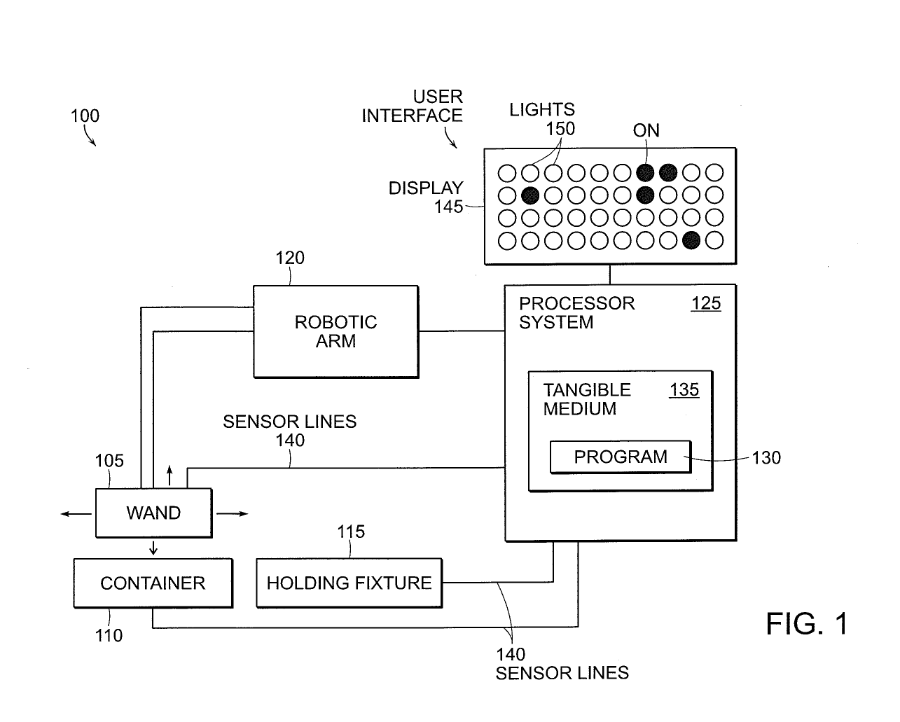

Referring now to the drawings, in which like reference numerals represent like parts throughout the several views, FIG. 1 shows a system 100 for collecting or gathering samples dispersed in a liquid within a container 110 and transferring the collected or gathered samples into discrete receptacles of a holding fixture 115, in accordance with many embodiments. The system includes a wand 105, a container 110 holding a liquid and having samples dispersed in the liquid, and a holding fixture having one or more discrete receptacles 115. The wand 105 is configured to draw one or more of the samples into contact with the head of the wand 105 and retain the samples using differential pressure as the wand 105 is removed from the liquid. In many embodiments, the head of the wand 105 includes a plurality of openings through which liquid is drawn to draw at least some of the samples into contact with an associated opening, where after differential pressure is used to retain the sample in contact with the associated opening. Relative movement between the wand 105 and the holding fixture having discrete receptacles 115 can be used to position the wand 105 to release retained samples into the holding fixture having discrete receptacles 115. In many embodiments, the wand 105 is configured to retain the samples in an array of positions that can be registered with a corresponding array of positions of discrete receptacles in the holding fixture 115 prior to releasing the retained samples into the corresponding discrete receptacles of the holding fixture 115. In other embodiments, the wand 105 is configured to release a plurality of samples into a single discrete receptacle of the holding fixture 115.

The wand 105 can be manually manipulated and/or optionally can be coupled with a mechanism, for example a robotic arm 120, for automatic manipulation of the wand 105. Manipulation of the optional robotic arm 120 can be controlled by an optional processor system 125 executing a program 130 stored on a tangible medium 135. The arm 120 can be configured with many degrees of freedom to move the wand 105 to a desired location and/or orientation. For example, the arm 120 can be configured to move the wand 105 with up to three translational degrees of freedom and up to three rotational degrees of freedom. For example, the arm 120 can be configured to orient the samples retained on the wand 105 for injection of a test substance with an automated injection device, prior to release of the samples into the holding fixture 115. The head of the wand 105 includes openings sized to retain the samples using differential pressure. The processor system 125 can be configured to place the wand 105 in the container to collect or gather samples and move the wand 105 from the container 110 to the holding fixture having discrete receptacles 115 and align the wand 105 with the holding fixture having discrete receptacles 115 prior to releasing the retained samples into associated discrete receptacles of the holding fixture 115.

The wand 105 can include one or more optional sensors for sensing when one or more samples are being retained in contact with the head of the wand 105. For example, the one or more sensors can include flow sensors positioned and configured to measure the flow of liquid through each of the openings in the wand head 105. The wand 105 can be connected to the processor system 125 with sensor lines 140 that extend from the head 105 to the processor system 125. The processor system 125 can be configured to determine the presence of one or more samples being retained in contact with the head of the wand 105 in response to a measurement signal(s) from the one or more sensors.

An optional display 145 can be coupled to the processor system 125 to indicate when one or more samples are being retained in contact with the head of the wand 105. The display can include one or more lights 150 to indicate when samples are retained via corresponding openings of the head of the wand 105. For example, the display can include a light 150 for each opening and each sensor can be linked with one light 150 of the display that is illuminated when a sample is retained in that particular opening. A user of the system 100 and/or the processor system 125 can issue a command to move the head 105 from the container 110 to the holding fixture having discrete receptacles 115 in response to a determination that a sufficient number of samples are retained by the head of the wand 105. The display can also be used for system diagnosis to assess whether the wand 105 is functioning properly, for example, by determining when one or more samples fail to release from the wand 105. At least when flow sensors are employed, the flow sensors can be used to detect clogging of the head of the wand 105 (e.g., clogging of the openings or internal passages of the wand head that are in fluid communication with the openings) by measuring the flow of liquid through the openings of the wand head.

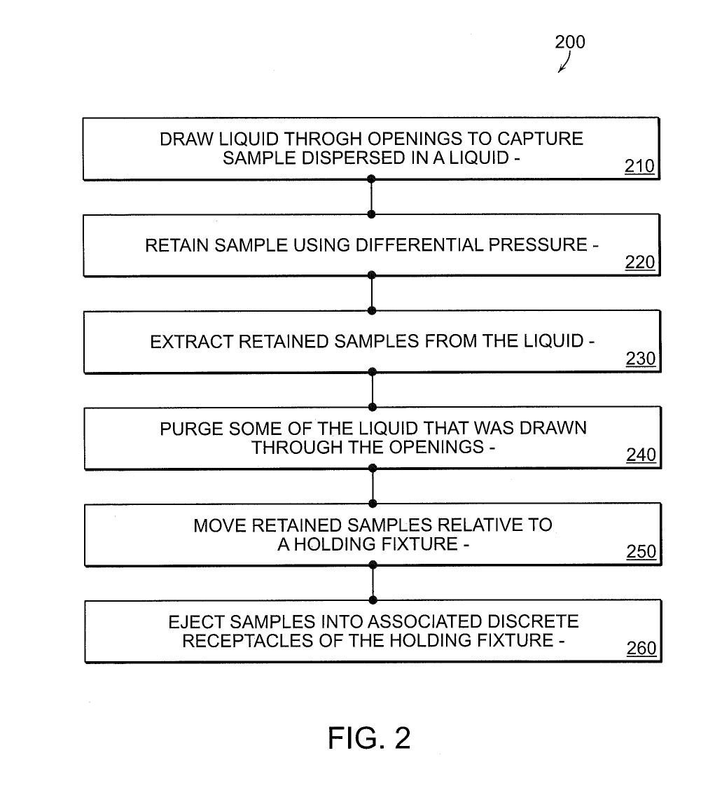

FIG. 2 illustrates a method 200 for collecting or gathering samples dispersed in a liquid and distributing the collected or gathered samples into discrete receptacles of a holding fixture, in accordance with many embodiments. The devices and systems disclosed herein can be used to practice most if not all of the steps of method 200. In step 210, liquid is drawn through openings to capture samples dispersed in a liquid. The openings are configured and sized such that the samples cannot pass through the opening when drawn into contact with the openings, but are instead (in step 220) retained using differential pressure. In step 230, the retained samples are extracted from the liquid via, for example, relative movement between a container holding the liquid and the dispersed samples and a collecting or gathering head having the openings used to capture the samples. Some of the liquid that was drawn through the openings can be purged in step 240. As will be described in more detail below, such purging of liquid can be accomplished while the samples are retained using differential pressure. In step 250 the retained samples are moved relative to a holding fixture. In step 260, the retained samples are released into discrete receptacles of the holding fixture. Additional steps and/or sub steps are possible as will be apparent to a person of skill in the art in light of the devices and systems described herein.

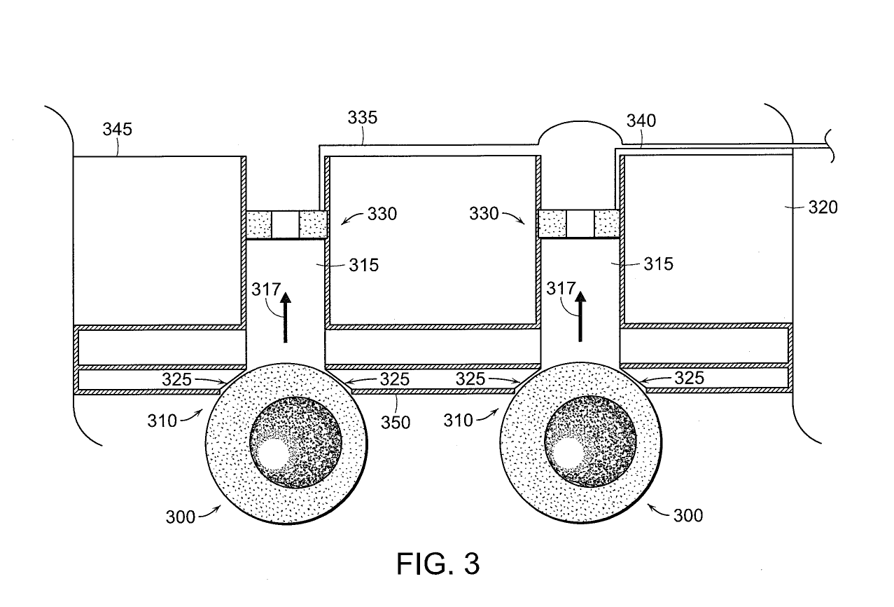

FIG. 3 illustrates exemplary samples (e.g., zebrafish eggs 300) retained in contact with a retention structure of a wand head via differential pressure, in accordance with many embodiments. The retention structure 320 includes a plurality of openings 310, each opening in fluid communication with an associated retention channel 315. Liquid is drawn through each of the retention channels 315 in the direction of the arrows 317 to draw a sample into contact with the associated opening 310 of the retention structure 320 of the wand head. Once a sample 300 is brought into contact with an opening 310, the sample 300 partially and/or substantially blocks further liquid flow through the retention channel 315, thereby causing the pressure in the retention channel 315 to drop such that a differential pressure is established. The pressure differential retains the sample 300 in contact with the opening 310 of the retention structure 320. In many embodiments, the openings 310 include a conically-shaped surface 325 that flares outward from the associated retention channel 315 to an exposed exterior surface 350 of the retention structure of the wand head 320. The conically-shaped surfaces 325 can be configured to interface with particular samples to, for example, retain the sample while distributing the force exerted against the sample as a result of the differential pressure over a suitable portion of the retained sample in order to reduce the possibility of injury to the retained sample. The upper surface 345 of the retention structure 320 can couple to the lower surface of a manifold.

In many embodiments, the retention structure 320 of the wand head includes a plurality of liquid flow sensors 330 positioned to determine the presence of samples 300 retained by the openings 310. Each of the flow sensors 330 can be disposed to measure the fluid flow in one of the retention channels 315 of the retention structure 320 of the wand head. The flow sensors 330 can be known sensors to measure the flow of a liquid, for example micro sensors. As the opening of the retention channel 315 can be sized to receive one sample 300, the flow sensor 330 can determine the presence of the sample 300 in the channel in response to reduced flow of liquid in the channel. Although liquid flow sensors are shown, many known sensors (e.g., pressure transducers) can be coupled to the channels 315 to determine the presence of the samples in the channels.

Each of the sensors 330 can be coupled to a line to transmit a signal from the sensor. For example a first sensor 330 can be coupled to line 1 (335), and a second sensor 330 can be coupled to line 2 (340). The flow sensor signal can be transmitted along the line 335 or 340 coupled to the sensor 330. The lines can include known methods of transmitting electrical signals, for example, printed circuit lines.

Some samples (e.g., zebrafish eggs 300) to be collected or gathered have a density greater than water and therefore tend to sink to the bottom of the container. The water flow rate through each opening 310 can be configured to draw the samples 300 upward from the bottom of the container into the openings 310 without harming or damaging a majority of the samples 300. Such flow rates can be determined experimentally on an empirical number of samples representative of a population of samples. Flow rates through each opening 310 (e.g., from about 1 ml per minute to about 20 ml per minute for some samples) can be used to draw the samples from the upper surface of the bottom of the container into the openings.

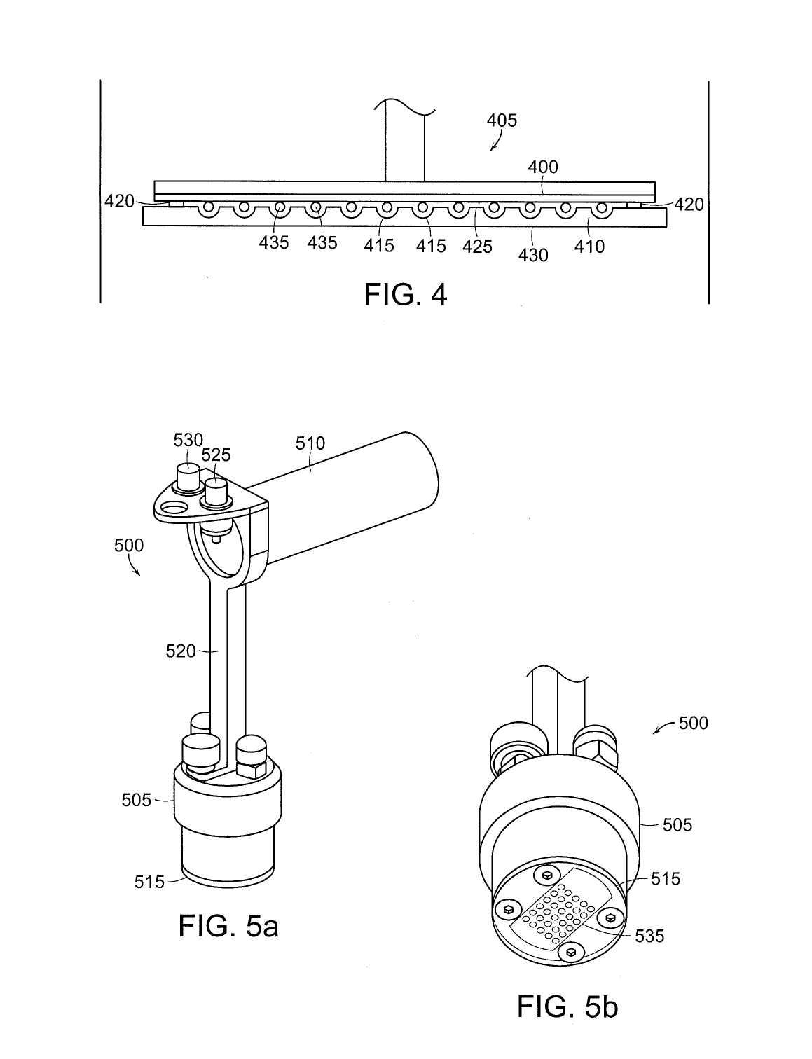

FIG. 4 illustrates the registration of a retention structure 400 of a wand head 405 configured to collect or gather and transfer samples with a holding fixture (e.g., a multi-well plate) 410. The holding fixture 410 includes discrete receptacles (e.g., wells) 415 to receive the samples. Alignment structures 420 located on the holding fixture 410 and/or the retention structure 400 of the wand head 405 can be configured to register the discrete receptacles 415 of the holding fixture 410 with the openings of the retention structure so that the discrete receptacles receive the samples 435. The holding fixture 410 has an upper surface 425 and a lower surface 430. A gas (e.g., nitrogen or air) can be injected into the wand head to eject the samples into the discrete receptacles 415.

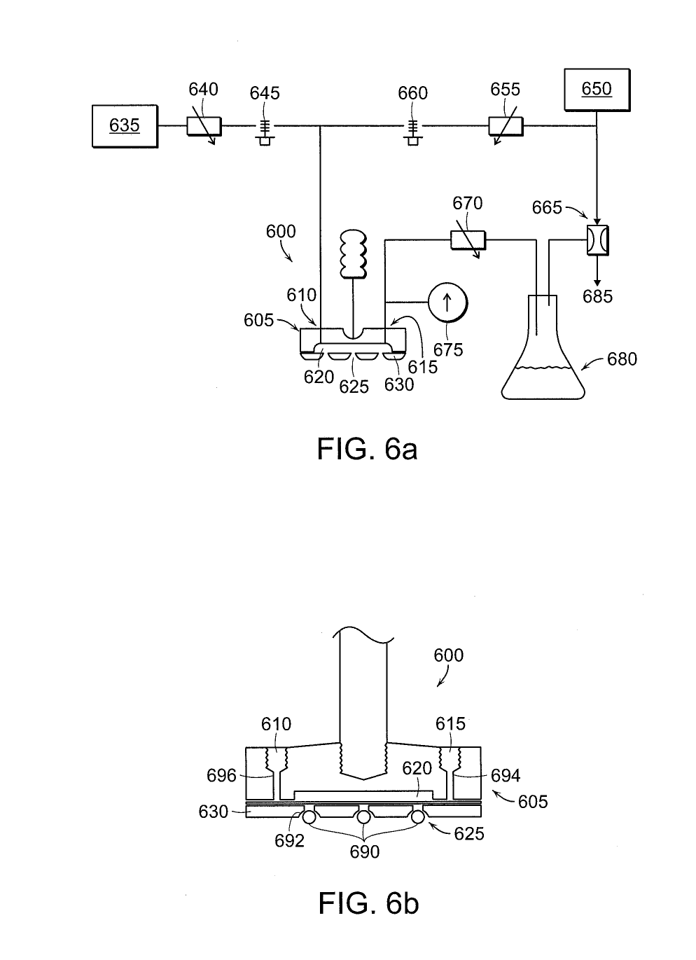

FIG. 5a shows a wand 500 for collecting or gathering samples dispersed in a liquid and transferring the collected or gathered samples into discrete receptacles of a holding fixture. The wand 500 includes a head 505 and a handle 510 coupled with the head 505 via a neck member 520. The head is configured to collect or gather samples from a vessel, or container, when the head 505 is positioned in the vessel. The head 505 includes a retention structure 515 having openings formed thereon sized to collect or gather the samples. The handle 510 can be used to manually place the head 505 in a vessel to collect or gather the samples. Alternatively or in combination, at least one of the handle 510 or the neck member 520 can be coupled to a robotic system 100 for automated transfer of the samples. A purge button 530 can be coupled with the head 505 and configured to introduce gas to purge liquid from the head 505 before the samples are released. A release button 525 can be coupled with the head 505 and, configured to control the flow of compressed gas into the head 505 to release the samples. The purge button 530 and release button 525 need not be located near the top of the neck member 520, but can be located along the side or elsewhere. In some cases, the volume of water released can be no more than about 3.4 μL or no more than about 1.7 μL.

FIG. 5b illustrates the head 505 of the wand 500 of FIG. 5a, in which the retention structure 515 has openings 535 sized to receive samples and retain the samples via differential pressure. The openings 535 are formed in a lower surface of the retention structure 515 of the wand head 505, such that one sample can be retained in each opening 535 when vacuum is applied to the head 505. The openings 535 can be sized such that each opening 535 can collect or gather one sample when vacuum is applied to the head 505. The lower surface of the retention structure 515 of the wand head 505 can be a surface configured to contrast optically with the samples, such that a user can determine when samples are retained at the openings 535. Some samples can be partially clear and scatter at least some light, such that a contrasting optical property on the lower surface of the retention structure 515 of the wand head 505 can be helpful to visually detect the samples retained on the retention structure 515. The lower surface can be at least one of a color, a shading, a pigment, or an anodized layer to enhance optical detection of samples retained in the openings of the retention structure 515 of the wand head 505.

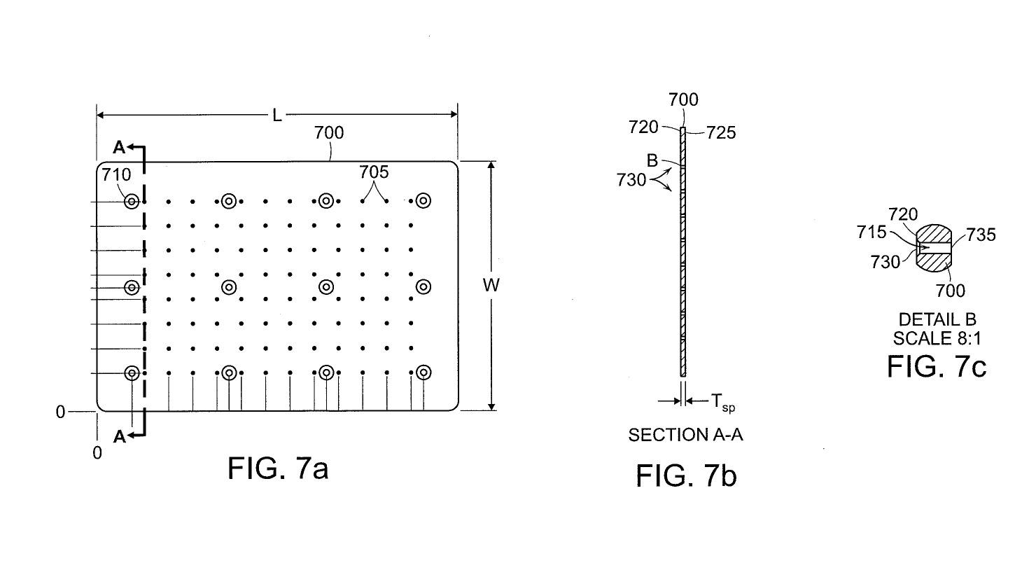

FIG. 6a schematically illustrates a device for collecting or gathering samples dispersed in a liquid and transferring the collected or gathered samples into discrete receptacles of a holding fixture, in accordance with some embodiments, for example, in accordance with the wand of FIGS. 5a and 5b. The device includes the wand 600 and associated valves, flow control devices, and conduits configured to draw water through the openings to draw the samples into contact with the openings, purge the manifold channel above the samples while retaining the samples in contact with the openings, and release the samples. The head 605 of the wand 600 includes a gas inlet 610 in fluid communication with a gas outlet 615 through a manifold channel 620. The manifold channel 620 is in fluid communication with each of the openings 625 in the retention structure 630 of the wand head 605. The gas inlet 610 is in fluid communication with a source of gas 635 (e.g., air) through a purge flow control mechanism 640 and a purge button 645. The purge flow control mechanism 640 can be a two-position valve (e.g., a valve having an open and closed position) or it can be a valve that permits varying flow rates. The gas inlet 610 is also in fluid communication with a source of compressed gas 650 through a release flow control mechanism 655 and a release button 660. The release flow control mechanism can be a two-position valve (e.g., a valve having an open and closed position) or it can be a valve that permits varying flow rates. The gas outlet 615 is in fluid communication with a fluid pump (e.g., a vacuum source, a mechanical pump) 665 through an aspirate flow control mechanism 670 controllable to regulate the flow rate of fluid drawn from the head 605 via the gas outlet 615. A pressure gage (e.g., “vac sense”) 675 is disposed to measure the level of vacuum at a suitable location between the aspirate flow control mechanism 670 and the openings 625 of the head 605. A trap 680 can be disposed between the vacuum source 665 and the aspirate flow control mechanism 670 to separate the fluid drawn from the head 605 into a gas (e.g., air) and a liquid (e.g., water). Alternatively, the aspirate flow control mechanism 670 and pressure gage 675 can be disposed between the trap 680 and the vacuum source 665.

When the purge flow control mechanism 640 is closed, vacuum from the vacuum source 665 draws water through the openings 625 and into the manifold channel 620. The water can be drawn through the openings 625 at a flow rate that is sufficient to draw the samples into contact with the openings without damaging a majority of the samples. In many embodiments, the flow rate through each opening is preferably from about 1 to about 20 ml/minute, and more preferably from about 2 ml to about 10 ml/minute. As the samples are drawn into contact with the openings 625, the pressure gage 675 assists in regulating the level of vacuum pressure applied to the gas outlet 615 so as to avoid subjecting the retained samples to excessive amounts of differential pressure.

A source of gas (e.g., air in the room) 635 can be introduced into the manifold channel 620 by pressing the purge button 645, which opens the purge control mechanism 640. Pressing the purge button 645 purges liquid from the manifold channel 620 while still retaining the samples in contact with the openings 625. By purging the liquid from the manifold channel 620, the amount of liquid subsequently released with each of the samples can be substantially limited to the amount of liquid disposed in the retention channel 692 coupled with the associated opening. For example, the combined volume of the sample and the liquid released with the sample can be limited to less than a volume of a corresponding well of a multi-well plate to avoid over filling the well of the multi-well plate. When the purge button 645 is pressed, air flows into the gas inlet 610 at a rate controlled by the purge flow control mechanism 640 that is selected to purge liquid from the manifold channel 620 without eliminating the vacuum pressure in the manifold channel 620 necessary to retain the samples in contact with the openings via differential pressure. When the purge button 645 is pressed, the pressure gage 675 assists in regulating the level of vacuum pressure applied to the gas outlet 615 so as to ensure sufficient vacuum pressure within the manifold channel 620 to retain the samples in contact with the openings via differential pressure.

The release button 660 can be operated to open the release flow control mechanism 655 in order to release the samples from the openings 625. Operation of the release button 660 causes an increase in pressure in the manifold channel 620 so as to reduce, cancel, or reverse the differential pressure applied to the samples via the openings 625 such that the samples are released or, in some instances, ejected from the openings 625. Pressing the release button 660 introduces a pressurized gas 650 (e.g., compressed air) into the manifold channel 620 via the gas inlet 610 and thereby increases the pressure within the manifold channel 620 so as to release or, in some instances, eject the samples from the openings. Although air is shown, many gases can be used, for example nitrogen gas. When the release button 660 is pressed, air flows into the manifold channel 620 at a rate controlled by the release flow control mechanism 655. The flow rate can be configured to minimize sample trauma (e.g., death of a zebrafish embryo) from the injection of the compressed air, and also to ensure that the samples remain in discrete receptacles of the holding fixture without excessive air blowing the samples out of the discrete receptacles of the holding fixture. The flow rate and pressure of the compressed air can be adjusted such that release occurs over a period of time within, for example, a range from about 0.1 to about 0.5 seconds after the release button 660 is pressed to trigger release. Such release rates can release the samples without harming a majority of the samples. Additional ranges can be determined with empirical studies on a representative population of particular samples, for example studies on eggs or embryos.

The source of compressed gas 650 can also be coupled to a venturi 665 to generate the vacuum source in fluid communication with the gas outlet 615. The compressed air passes through the venturi 665 and exits the venturi as exhaust 685. The vacuum of the venturi is coupled to the trap 680. The trap 680 is configured to collect liquid aspirated from the gas outlet 615 of the head 605. The aspirate flow control mechanism 670 is coupled to the trap 680 and the gas outlet 615 to control the flow rate of fluid aspirated from the head 605. The pressure sensor 675 is coupled to a vacuum line extending from the head 605 to the aspirate flow control mechanism 670 and configured to sense or measure the vacuum in the vacuum line.

FIG. 6b schematically illustrates a cross section of the wand head 605 of the device of FIG. 6a. A plurality of samples 690 is shown retained in a plurality of the openings 625, with one sample per opening. Each opening 625 can be defined by a retention channel 692 formed in the retention structure 630 of the wand head 605 to retain a sample 690, for example the retention channel 692 having an outer diameter near the bottom of the retention structure 630 of the wand head 605 and a reduced inner diameter. The gas outlet 615 is coupled to a fluid pump 665 (e.g., a vacuum source, a mechanical pump, a venturi) to draw liquid through the openings 625 when a vacuum is applied to the gas outlet 615. At least one manifold channel 620 can extend between the gas outlet 615 and the retention channels 692, so as to couple the retention channels 692 with the fluid pump. A gas outlet channel 694 can extend from the gas outlet 615 to the manifold channel 620. The gas outlet channel 694 between the gas outlet 615 and the manifold channel 620 can be smaller in cross-sectional area than the gas outlet 615 such that the gas outlet channel 694 restricts or limits the vacuum in the manifold channel 620 such that trauma and death of biological samples 690 can be minimized when the biological samples are vacuumed into the openings 625. Restricting the cross-sectional area of the gas outlet channel 694 can also increase uniformity of a pressure drop along the manifold channel 620, such that water is drawn through the openings coupled to the manifold channel 620 with improved uniformity. The manifold channel 620 can extend internally along the head 605 and can couple the openings 625 to the gas outlet 615. The gas inlet 610 can be coupled to the manifold channel 620 opposite the gas outlet 615 to allow a gas (e.g., air) to enter the manifold channel 620. A gas inlet channel 696 extending from the gas inlet 610 to the manifold channel 620 can be smaller in cross-sectional area than the gas inlet 610. The gas inlet channel 696 can be sized to generate a sufficient pressure drop across the gas inlet channel 696 when gas flows through the gas inlet channel 696 and into the manifold channel 620 such that a sufficient level of vacuum pressure is maintained in the manifold channel 620 to retain the samples 690 in contact with the openings 625 via differential pressure. Each of the channels 694 and 696 connects to the manifold channel 620 at the bottom such that gas can pass through the manifold channel 620 to purge liquid from the manifold channel 620 while liquid is retained in each of the retention channels 692. Compressed gas 650 can be injected into the gas inlet 610 to eject the samples 690 from the openings 625 into discrete receptacles of a holding fixture.

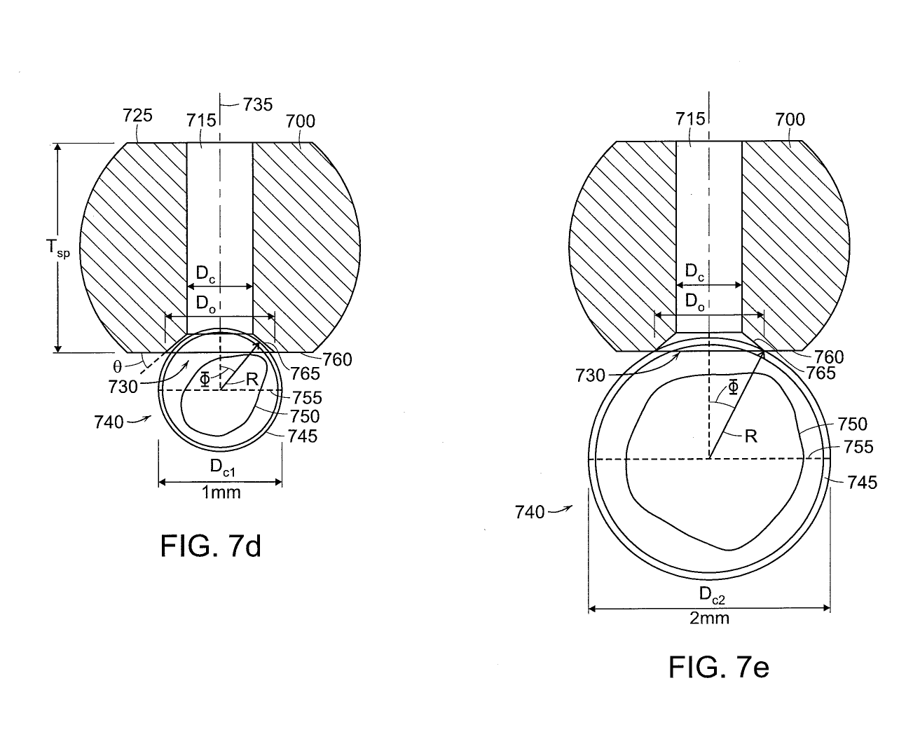

FIG. 7a illustrates a retention structure 700 that can be attached to the bottom face of the wand head and thus can form a component of the wand head. In this particular illustration, the retention structure 700 has ninety-six openings 705 for use in collecting or gathering samples dispersed in a liquid and transferring the collected or gathered samples to the wells of a ninety-six well plate. The ninety-six openings can be arranged in, for example, an eight by twelve array. The retention structure 700 can include mounting holes 710 for mounting the retention structure 700 to a manifold. The number of openings formed in the retention structure can correspond to a number of openings in a commercially available well plate, for example 6, 12, 24, 48, 96, 384 or 1536 well plates. The device can be configured to release a single sample into a discrete receptacle of a holding fixture. The device can be configured such that any number of samples can be released into a discrete receptacle of a holding fixture. Fox example, the device can be configured to release two, three, four, five, or more samples into each well of a 24-well plate. The device is not limited to releasing multiple samples into each well of a 24-well plate, and can be configured to release multiple samples into each well of any commercially-available well plate by arranging the openings as desired. For example, the handheld wand can be used to place a plurality of samples, such as 30 zebrafish eggs, into a single well of a 6-well plate or into a Petri dish. In some embodiments, the openings are arranged in a rectangular array with approximately 0.354 inches between adjacent rows of openings and between adjacent columns of openings.

FIG. 7b shows a side-cross sectional view of the retention structure 700 of FIG. 7a. The retention channels 715 can have openings 730 that extend through the retention structure 700. The retention structure 700 can include a lower surface 720 configured to collect or gather the samples and an upper surface 725 configured to contact the manifold. The retention structure 700 has a thickness Tₛₚ.

FIG. 7c is a cross-sectional view illustrating a retention channel 715 extending through the retention structure 700 so as to define an opening 730 in the lower surface 720 of the retention structure 700. Each opening 730 can be sized to retain a sample. Each retention channel 715 extends through the retention structure 700 to couple the opening 730 to the manifold channel of the manifold. The retention channel 715 extends through the retention structure 700 along an axis 735. For example, the opening 730 and the retention channel 715 can extend along a vertical axis 735 when the retention structure 700 is placed in liquid to collect or gather samples.

FIG. 7d is a cross-sectional view illustrating the retention of an exemplary 1 mm diameter sample 740 in contact with the retention structure 700 of FIGS. 7a, 7b, and 7c. The retention channels 715 and openings 730 of the retention structure 700 can be sized based on the sizes of the samples to be collected or gathered, retained, and released, for example, as a function of the sizes of the samples. For example, when the samples are zebrafish eggs, a portion of the chorion 745 can be retained in contact with the retention structure 700. The chorion 745 is the outermost membrane disposed around the periphery of the embryo 750 and serves to protect the embryo 750. The chorion 745 can be a substantially spherical outer surface that corresponds to an outer surface of the embryo 750. The chorion 745 has a diameter across, for example, an equator 755 that divides the chorion into an upper half and a lower half. The opening has an opening diameter Dₒ and the retention channel has a channel diameter D_{c}. The lower surface 760 of the retention structure 700 can have a smooth surface made from a smooth material, which minimizes damage to the samples and sticking of the samples to the lower surface 760 of the retention structure 700 when the samples are released. The lower surface 760 of the retention structure 700 and/or the openings 730 can be at least one of a polished surface, a polished metal, a smooth metal, anodized aluminum, acetal, DELRIN, TEFLON, or polycarbonate.

The dimension of the retention channel 715 defining the opening 730 can be sized near the lower surface 760 to accommodate many sizes of samples, such that the dimensions of the opening 730 and the retention channel 715 can be based on the sizes of the samples handled. For example, the opening diameter Dₒ forming the maximum dimension across the retention channel 715 at the opening 730, the channel diameter D_{c} forming the minimum dimension across the retention channel 715, and the inclined surface 765 in between can be sized and sloped in many ways to handle the samples. The opening diameter Dₒ defined by the maximum dimension across the retention channel 715 can be larger than the channel diameter D_{c} such that an inwardly inclined surface 765 extends from the opening 730 to the channel diameter D_{c}.

The opening diameter Dₒ forming the maximum distance across the retention channel 715 at the opening 730 and the channel diameter D_{c} can be sized based on the diameter of the samples 740 handled. For example, the opening diameter Dₒ can correspond to no more than about 100% of the diameter of the largest samples handled, for example 75% of the diameter of the largest samples handled. The minimum diameter of the channel D_{c} can be no more than about 100% of the diameter of the smallest samples handled, for example 75% of the diameter of the smallest samples handled. For example, with samples having a range of sizes corresponding to a largest diameter across of about 25 mm and a smallest diameter across of about 12 mm, the opening diameter Dₒ can be about 25 mm across and the minimum channel diameter D_{c} can be 9 mm across.

As a specific example, the retention channels and openings can be sized for the handling of fertilized zebrafish eggs, which can be approximately 1.0 mm. For example, the minimum retention channel diameter D_{c} can be sized smaller than 1.0 mm, the smallest size of the zebrafish eggs. The minimum channel diameter D_{c} can be within a range from about 0.25 to about 1.0 mm, for example within a range from about 0.25 mm to about 0.75 mm, and can be any value within the range such as about 0.5 mm. The opening diameter Dₒ forming the maximum dimension across the retention channel 715 can be from about 0.35 mm to about 2 mm, for example from about 0.5 mm to about 1.5 mm, and can be any value within the range such as about 0.8 mm.

The opening diameter Dₒ along the lower surface 760 can be less than the diameter of the sample 740, and the minimum diameter D_{c} of the retention channel 715 can be less than a diameter of the opening 730, such that an inclined surface 765 extends between the opening diameter and the minimum diameter. The opening can be defined with a conically-shaped surface 765, and the conically-shaped surface 765 can be inclined relative to the lower surface 760 of the retention structure 700 with an inclination angle Θ. The inclination angle Θ can be within a range from, for example, about 30 to 50 degrees such as about 40 degrees. A substantially spherical sample 740 can be retained in the opening 730 so as to substantially align the sample with the axis 735 of the retention channel 715 so as to define an azimuthal contact angle Φ relative to the axis 735 of the retention channel 715. The azimuthal contact angle Φ can correspond to a portion of the sample 740 that contacts the opening 730 in relation to the axis 735 of the retention channel 715. The inclined conically-shaped surface can define an annular zone formed in the retention structure 700, such that contact of the sample 740 with the conically-shaped surface 765 can form a seal between the sample 740 and the retention structure 700.

The use of an opening diameter Dₒ smaller than a diameter of the sample can improve handling of the sample. An opening diameter Dₒ smaller than the sample diameter limits the extent to which the sample passes the lower surface 760 of the retention structure 715, and can minimize sticking of the sample to the retention structure 715. For example, as illustrated in FIG. 7d, when a 1 mm diameter sample 740 is retained via a retention channel 715 with an opening diameter Dₒ equal to about 0.8 mm and a channel diameter Dc equal to about 0.5 mm, the sample extends into the opening by no more than about a quarter of the 1 mm distance across the sample. The 1 mm sample can also form a seal with the inclined conically-shaped surface 765. Additionally, a conically-shaped surface 765 having an angle of inclination Θ from about 30 to about 50 degrees can facilitate handling of the sample as the inclination angle Θ can approximate the azimuthal angle Φ of where the sample contacts the inclined surface 765 and can also minimize deformation of the sample 740 while the sample 740 is retained in contact with the inclined surface 765 via differential pressure.

FIG. 7e is a cross-sectional view illustrating the retention of an exemplary 2 mm diameter sample 740 in contact with the retention structure of FIGS. 7a, 7b, and 7c. The 2 mm diameter sample 740 can contact the inclined surface 765 at the intersection of the lower surface 760 with the inclined surface 765. When the sample 740 is retained by the retention structure 700, the 2 mm diameter sample 740 extends into the opening 730 by no more than about one tenth of the distance across the sample 740. The 2 mm diameter sample 740 can also form a seal with the inclined surface 765.

The chorion 745 of many species of fish, for example zebrafish, has an outside diameter of approximately 1 mm. Accordingly, as illustrated in FIGS. 7d and 7e, openings 730 having a diameter less than 1 mm can be used to collect or gather a batch of fertilized fish eggs having outside diameters of approximately 1 mm.

When samples 740 are retained in the openings 730 and air is introduced into the manifold channel, the liquid is purged from the manifold channel while liquid is retained in the retention channels. The liquid retained in each of the retention channels can be subsequently released along with an associated retained sample.

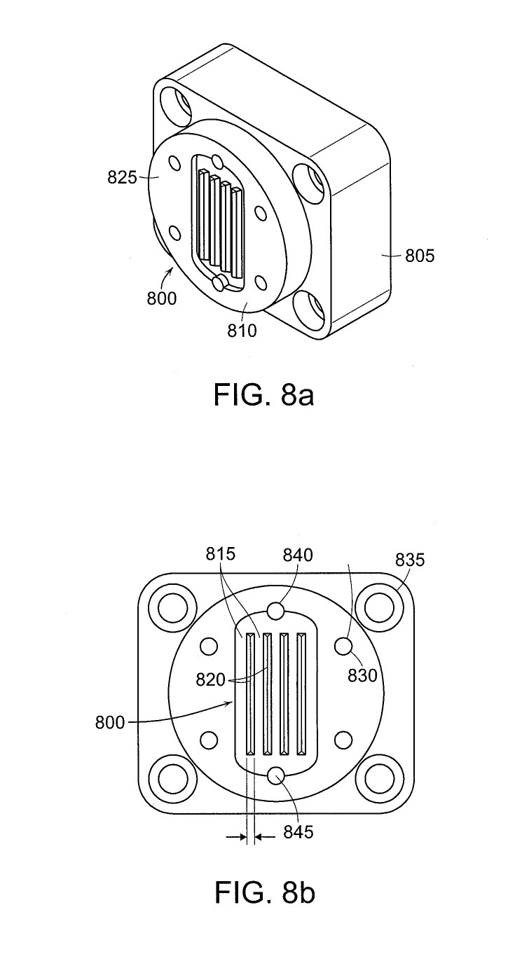

FIG. 8a is a perspective view illustrating a manifold 800 for use with the device of FIG. 5a. FIG. 8b shows an end view of the manifold 800. The manifold 800 forms a component of the wand head. The manifold 800 can be coupled to the retention structure to more evenly distribute the vacuum to the openings, and also to more evenly distribute gas passing through the openings when the samples are released. This more even distribution of pressure among the openings can minimize trauma to samples and ensure that the samples are processed similarly and so that parameters of the gas flow system can be optimized. The manifold 800 can have a block-shaped body 805. The block-shaped body 805 can have a lower surface 810 having manifold channels 815 formed therein. The manifold channels 815 can be machined into the lower surface 810 of the block-shaped body 805 to define protrusions 820. The protrusions 820 can extend from a base 825 toward the retention structure so as to contact the retention structure and define the manifold channels 815. In other words, the protrusions 820 define the boundaries of the manifold channels 815. The block-shaped body 805 can have at least one mounting hole 830 for mounting the retention structure to the block-shaped body 805. The block-shaped body 805 can also include at least one handle hole 835 for mounting the block-shaped body 805 to the neck member. The block-shaped body 805 can include a gas inlet channel 840 and a gas outlet channel 845.

The manifold 800 and the retention structure can be configured for many configurations of openings in the retention structure. For example, the retention structure can have a five by six array of openings, in which the block-shaped body 805 has five manifold channels 815, with each manifold channel 815 coupled with six retention channels, each of which extends to an opening.

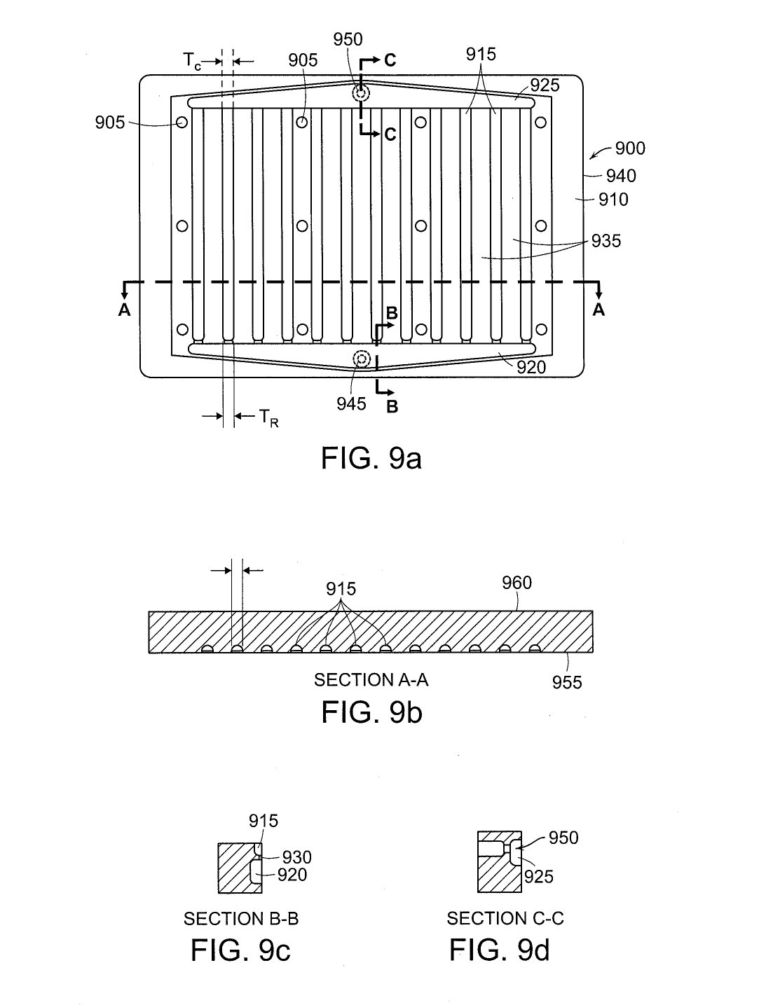

FIG. 9a is an end view of a manifold for the retention structure of FIGS. 7a to 7e. The manifold 900 includes mount holes 905 to mount the retention structure to the manifold 900. The manifold 900 can have a lower side 910 having manifold channels 915 formed therein coupled to the retention channels. For example, the manifold 900 can include a plurality of manifold channels 915 configured to extend substantially horizontally along the retention structure when the retention structure is positioned to collect or gather the samples.

Each of the manifold channels 915 can have an inlet chamber 920 on a first end and an outlet chamber 925 on a second end opposite the first end, such that liquid can be substantially purged from the manifold channels 915 while the samples are retained in contact with the retention structure via differential pressure. An upstream end of each manifold channel 915 intersects an inlet chamber 920, such that each upstream end is disposed upstream of the retention channels 915. A downstream end of each manifold channel 915 intersects an outlet chamber 925, such that each downstream end is disposed downstream of the retention channels 915. A restriction 930 can be disposed on the upstream end of each manifold channel 915 in order to more evenly distribute the flow of air, and also the vacuum pressure, throughout the manifold channels 915, and in particular in the manifold channels farther away from the gas inlet channel 945 and the gas outlet channel 950. Each manifold channel 915 can have a channel width T_{c}, and each restriction 930 can have a restriction width Tᵣ. Each manifold channel 915 can also have a channel height, and each restriction can have a restriction height, with the height of the restriction less than the height of the channel. The restriction width can be less than the channel width. Protrusions 935 extend between the manifold channels 915. The protrusions 935 extend from a base 940 to contact the retention structure. The protrusions 935 and peripheral portion of the retention structure can be disposed substantially along a plane, such that the retention structure forms a seal with the manifold when the retention structure is placed on the manifold. Mount holes 905 can extend into the manifold 900 to mount the retention structure on the manifold 900. The manifold 900 can include a gas inlet 945 and a gas outlet 950.

FIG. 9b shows a cross-sectional view A-A of the manifold of FIG. 9a. The manifold channels 915 are shown formed in the lower surface 955 of the manifold 900. The manifold can have an upper side 960 opposite the lower side 955.

FIG. 9c is a cross-sectional view of the manifold of FIG. 9a illustrating a manifold channel restriction 930 disposed between the inlet chamber 920 and an associated manifold channel 915. The restriction 930 has a width and a height, each of which can be less than the length and height of the manifold channel 915. The inlet chamber 920 extends substantially perpendicular to the manifold channels 915 to allow air to enter the manifold channels 915 to purge liquid from the manifold channels 915 prior to the releasing the samples. The outlet chamber 925 is connected with each of the manifold channels 915 opposite the inlet chamber 920. The outlet chamber 925 extends substantially perpendicular to the manifold channels 915 and substantially parallel to the inlet chamber 920. The inlet chamber 920, the outlet chamber 925, and the manifold channels 915 extend along a plane, and the retention channels extend substantially perpendicular to this plane.

FIG. 9d is a cross-sectional view of the manifold of FIG. 9a illustrating the gas outlet 950 in fluid communication with the outlet chamber 925. The gas outlet 950 extends to the outlet chamber 925 to couple the outlet chamber 925 to the vacuum source.

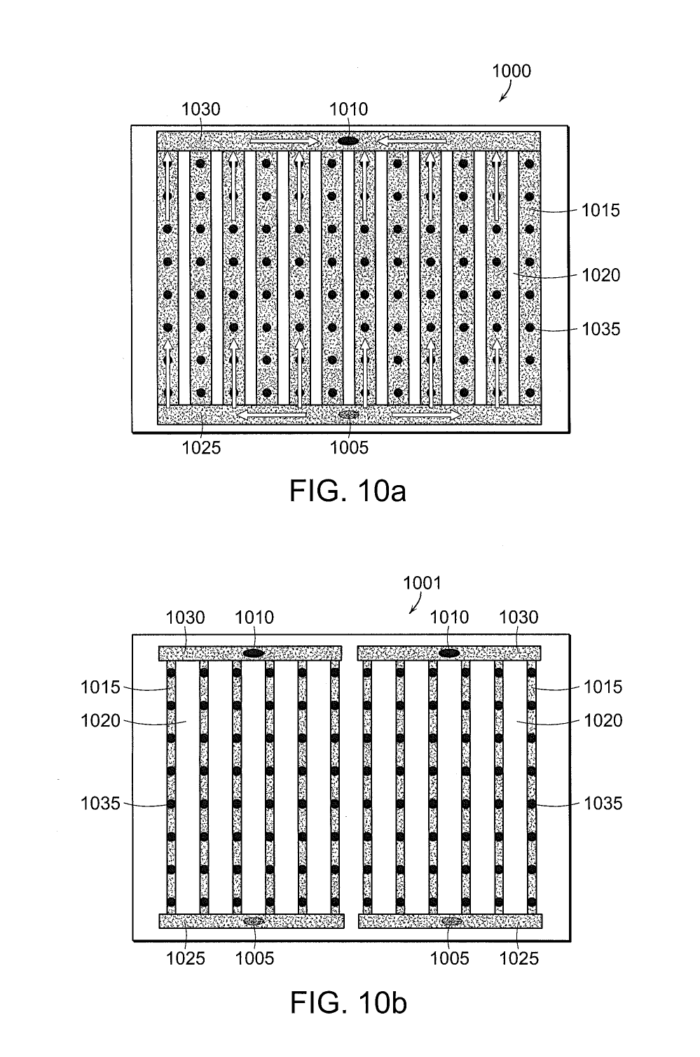

FIG. 10a illustrates the expected air and water flow paths for the manifold 1000 of FIGS. 7a-7e and 9a-9d. Gas enters through the gas inlet 1005. Water and gas exit through the gas outlet 1010. The manifold channels 1015 are separated by a series of protrusions 1020. Each of the manifold channels 1015 connects between an inlet chamber 1025 and an outlet chamber 1030. In this particular embodiment, each of the twelve manifold channels 1015 has eight openings 1035. As compared to the manifold design of a wand head having thirty openings, such as the wand of FIGS. 5a-5b and 8a-8b, the manifold 1000 of FIG. 10a has an increased number of openings per channel volume, an increased total volume of connected channels, and a greater maximum distance between the openings 1035 and the gas inlet 1005 and vacuum outlet 1010. In operation, the manifold of FIG. 10a requires a greater final vacuum pressure (FVP) in order to achieve 100% occupancy of the openings. A lower final vacuum pressure is desirable because higher final vacuum pressures are more likely to harm the samples.

FIGS. 10b and 10c illustrate alternative manifold designs for a wand head having ninety-six openings. The wand head of FIG. 10b has two manifolds, with each manifold having a gas inlet 1005, an inlet chamber 1025, a gas outlet 1010, and an outlet chamber 1030. The wand head of FIG. 10c has four manifolds 1002, with each manifold having a gas inlet 1005, an inlet chamber 1025, a gas outlet 1010, and an outlet chamber 1030. Compared to FIG. 10a, the manifold designs of FIGS. 10b and 10c each have a decreased number of openings per channel volume, a decreased total volume of connected channels, and a decreased maximum distance between the openings and the gas inlet and vacuum outlet. The manifold designs of FIGS. 10b and 10c are expected to require a lower final vacuum pressure (FVP) in order to achieve 100% occupancy of the openings as compared to the manifold design of FIG. 10a.

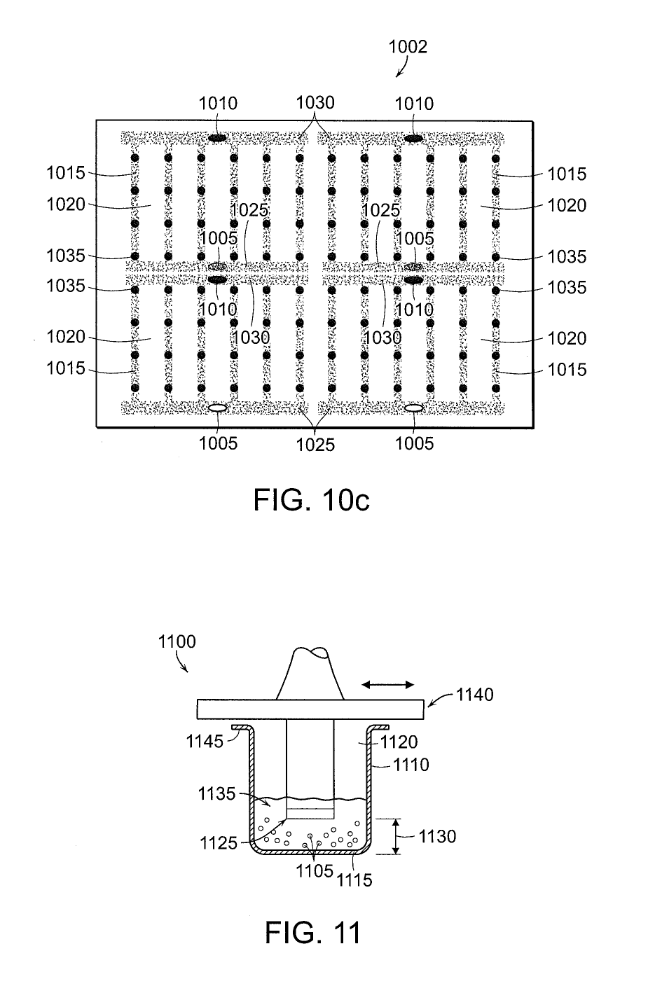

FIG. 11 diagrammatically illustrates the use of a wand 1100, such as described herein, positioned to collect or gather exemplary samples 1105 dispersed in a liquid 1135 within a container 1110. The container has an inner surface 1115 configured to retain liquid 1135 and an opening 1120 sized to receive the wand head 1100. The wand head 1100 can extend downward into the vessel 1110, such that a lower surface of the retention structure 1125 is positioned at a predetermined distance 1130 above an inner surface 1115 of the container 1110. The liquid 1135 in the container can be many known solutions for use with the samples involved. For example, when the samples 1105 are zebrafish eggs, the liquid 1135 in the container 1110 can be a solution with nutrients for zebrafish eggs with an osmolarity suitable for survival of the zebrafish eggs. Vacuum is applied to the wand head 1100 so as to draw some of the liquid through openings on the lower surface of the retention structure 1125. Where the density of the samples 1105 involved is greater than the liquid 1135 it can be helpful to stir the liquid 1135 depending on the predetermined distance 1130. A positioning structure 1140 can be affixed to the wand 1100 to position the lower surface of the retention structure 1125 at a predetermined distance 1130 above the inner surface 1115 of the container 1110. The positioning structure 1140 can be a plate, a ring, and/or protrusion extending from the handle and configured to contact an upper structure 1145 of the vessel 1110, for example an upper rim 1145, to position the lower surface of the retention structure 1125 at the predetermined distance 1130. The predetermined distance 1130 can be selected to be suitable for the samples involved, for example, within a range from about 1.25 to about 2.5 times the diameter of the samples (e.g., for samples from about 1 mm to 2 mm in diameter the predetermined distance can be about 1.25 to about 4 mm). The positioning structure 1140 can be slid along the upper surface of the container 1110 when the lower surface of the retention structure 1125 is at the predetermined position 1130 above the inner surface of the container.

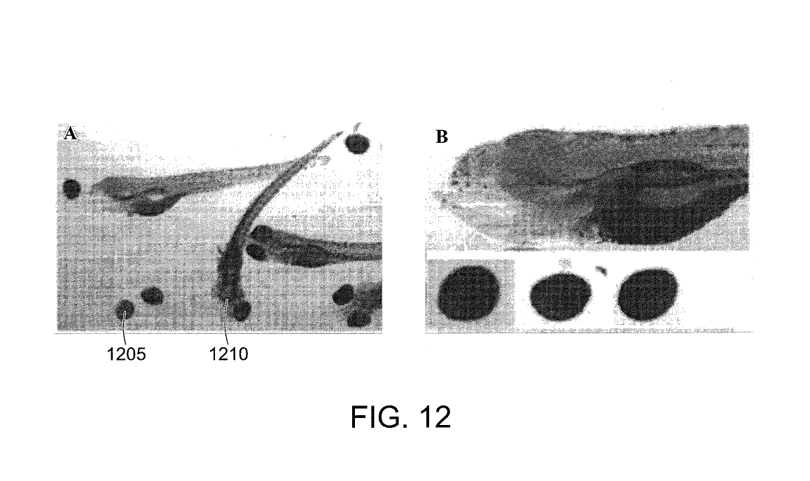

FIG. 12 shows a particular example of samples, in this case eyes 1205 removed from 5 days post-fertilization (dpf) zebrafish 1210 using collagenase treatment, that can be collected or gathered using the devices described herein. Enzymatic treatment, such as, e.g., with a collagenase, can be used to dissociate the eyes from an intact body of a teleost without laborious manual dissection and deleterious effect on the isolated eyes. Using enzymatic treatment, the eyes and the body of zebrafish remain generally intact. For example, using enzymatic treatment with a collagenase, the eyes and the body of zebrafish remain intact, with only ˜10% zebrafish having remnants of eye blood vessels remaining in the eye socket in the detached body. The preparation of eyes is described in U.S. Pat. No. 7,897,363, entitled “Methods of Screening an Agent for an Activity in an Isolated Eye of a Teleost”, filed on Jun. 11, 2008, the full disclosure of which is incorporated herein by reference and suitable for combination in accordance with embodiments, and corresponding PCT publication WO/2008/154641.

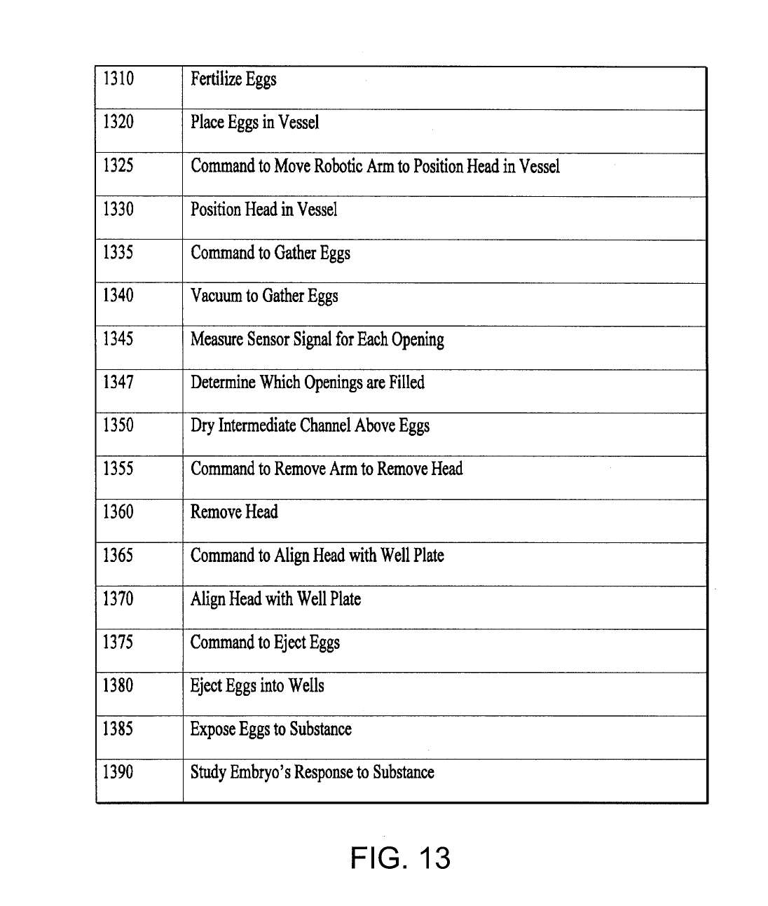

FIG. 13 shows a method 1300 for studying the response of embryos (e.g., fish embryos, frog embryos, invertebrate embryos, vertebrate embryos) to a test substance. The devices described herein can be used in the performance of the method 900.

In step 1310, eggs are fertilized. The eggs are referred to as embryos after fertilization. In step 1320, the eggs are placed in a vessel. The eggs can be placed in the vessel with a suitable liquid (e.g., water, a solution of water and suitable nutrients). In step 1325, a command is issued to move a robotic arm so as to position the head of a wand described herein into the vessel. In step 1330, the wand head is positioned into the vessel, for example, with the robotic arm in response to the command. The wand head is positioned in the vessel such that openings of the wand head are immersed in the liquid at, for example, a predetermined distance as described above. In step 1340, vacuum is applied to the wand head to draw the eggs into contact with the wand head, and in particular with the openings of the retention structure. The vacuum draws liquid through the openings, as described above. In step 1345, signals from sensors associated with each opening are processed. The sensors can include, for example, a flow sensor coupled with each opening. Based on the processing of the signals, in step 1347, a determination is made as to which of the openings are retaining an egg. The step 1347 determination can be accomplished with, for example, a processor system as described above. For example, the processor system can determine that an opening is filled in response to the flow of liquid through the opening falling below a threshold flow value. In step 1350, air is introduced into the manifold channel(s) as described above to purge liquid from the manifold channel(s). Step 1350 can be accomplished, for example, in response to a determination that a sufficient number of eggs are being retained in contact with the openings. Retention channels can extend between the manifold channel(s) and the openings to couple the openings to the manifold channel(s) as described above. A quantity of liquid can be disposed in the retention channel above each egg when the egg is retained in the opening and the liquid has been purged from the manifold channel(s). In step 1355, a command is issued to move the wand head. In step 1360, the wand head is removed from the vessel. For example, the head can be removed from the vessel in response to a command from the user and/or the processor system. With the wand head removed from the vessel, the retained eggs can be treated with a test substance prior to release from the head. For example, an automated injection of the retained eggs using a suitable mechanism can be accomplished. In step 1365, a command is issued to align the head with the multi-well plate, petri dish, or other suitable receptacle. In step 1370, the head is aligned with a multi-well plate to, for example, align each of the openings with one well of the multi-well plate. In step 1375, a command is issued to release the eggs from the wand head. In step 1380, the eggs are released from the wand head into the wells. The eggs can be released with a quantity of the liquid. In step 1385 the eggs are exposed to a test substance. The eggs can be exposed to the agent in many ways, for example, as described in U.S. Pat. No. 6,299,858, the full disclosure of which is incorporated herein by reference. Alternatively or in combination, the eggs can be exposed to the test substance with an automated injection apparatus while each of the eggs is retained in one of the openings of the head prior to release. In step 1390, the response of the eggs to the test substance is studied. The response can be studied with known methods and apparatus for screening substances and compounds.

It should be appreciated that the specific steps of method 1300 provide a particular approach to studying the response of eggs to a test substance. Other sequences of steps can be used without deviating from the spirit of the invention disclosed herein. For example, the steps outlined above can be performed in a different order. Moreover, the individual steps of method 1300 can include one or more sub-steps that can be performed in various sequences as appropriate to the individual step. Furthermore, additional steps can be added or removed depending on the particular application. One of ordinary skill in the art would recognize many variations, modifications, and alternatives.

TABLE I
Exemplary Samples and Sizes

| | | Represen- |
|---|---|---|
| Category | Exemplary Samples | tative size |
| Vertebrate/ | teleost eggs, zebrafish eggs, salmonid eggs, | 1 mm to |
| Fish Eggs | salmon eggs, salmo salar eggs, salvelinus | 10 mm |
| and Embryos | fontinalis, salmo trutta, oncorhynchus | |
| | tshawytscha, oncorhynchus keta, | |
| | oncorhynchus kisutch, oncorhynchus clarki, | |
| | salvelinus namaycush, oncorhynchus | |
| | gorbuscha, oncorhynchus mykiss, | |
| | oncorhynchus nerka, trout eggs, bass eggs, | |
| | seabass eggs, gilthead seabream eggs, | |
| Vertebrate/ | wood frog eggs, western chorus frog eggs, | 0.5 to |
| Frog Eggs | northern spring peeper eggs, northern | 3 mm |
| and Embryos | leopard frog eggs, pickerel frog eggs, eastern | |
| | American toad eggs, eastern gray treefrog | |
| | eggs, Cope's gray treefrog eggs, Blanchard's | |
| | cricket frog eggs, mink frog eggs, green frog | |
| | eggs or bullfrog eggs | |
| Invertebrate/ | caenorhabditis elegans | <1 mm |
| Worm Eggs | | |
| and Embryos | | |
| Isolatable | Teleost eyes, zebrafish eyes | <1 mm |
| Organs | | |
| Embryos | mouse, drosophila | <1 mm |

Table I lists examples of samples that can be transferred in accordance with the teachings described herein. One of ordinary skill in the art will recognize additional samples that can be transferred in accordance with the teachings described herein. For example, samples of particulate mass. The sizes of the retention channels and/or the openings in the retention structure can be adjusted based on the sizes of the samples involved. The sizes of the samples can be determined experimentally by one of ordinary skill in the art, and the dimensions of the retention channels and/or the openings can be scaled accordingly. The samples transferred in accordance with the teachings herein can include, for example, eggs laid by an animal and/or oocytes harvested from ovaries. Methods and apparatus for the isolation of teleost eyes are described in U.S. Pat. No. 7,897,363, entitled “Methods of Screening an Agent for an Activity in an Isolated Eye of a Teleost”, filed Jun. 11, 2008, the full disclosure of which has been previously incorporated by reference. One of ordinary skill in the art can determine the sizes of the samples to be transferred and size the retention channels and openings accordingly.

The devices, systems, and methods described herein can be combined with many known methods of testing and evaluating substances such as foreign genetic materials, proteins and other compounds. Also, the test substance can be administered before, during or after the samples are retained with the device.

Embodiments as described herein are well suited to handling samples of many sizes, and the devices and systems as described herein can be sized, for example scaled, based on the size of the collected or gathered and transferred samples. For example, the sample can be at least one cell, such as an ovum of an egg, and the collecting or gathering device can be sized to the egg.

Embodiments as described herein are well suited for combination with automated patching systems that use vacuum to attach cells. For example, a vacuum system micropipette having a diameter of around 1 μm and based on liquid flow through systems able to handle cells can be modified and combined in accordance with the teachings described herein.

Embodiments as described herein can be particularly well suited for sorting based on sample size. For example, a fine screen can be positioned beneath openings of the collecting or gathering devices so as to filter samples based on size. Small samples can pass through the screen and be collected or gathered by the head whereas larger samples are blocked by the screen. Such sorting can be useful with many samples such as combinatorial beads, seeds, and tissue clumps such as zebrafish eyes. To handle samples denser than zebrafish eggs, the vacuum pressure can be adjusted accordingly. Embodiments can be configured to handle larger samples having a maximum length across of at least about 1500 μm.

Embodiments as described herein may be particularly well suited for use with binding agents. A membrane can be embedded with a binding agent such that the retention structure can collect or gather and bind to samples such as combinatorial beads or cells. The membrane can be removed and a biochemical or cellular assay performed. For example, the assay can include molecular detection of a specific DNA sequence or specific RNA sequence such as a Southern blot or a Northern blot, for example, in which the membrane is held to the retention structure with low vacuum, and the membrane is placed in a media including cells. The cells are pulled toward and attached to the membrane by the vacuum. The membrane and bound samples such as cells can be exposed to reagents so as to carry out the assay, and many reagents can be used depending on the assay employed.

### II. Experimental Studies

Many of the structures and circuitry of the above described devices can be optimized to minimize sample trauma, for example death, when the samples are collected or gathered and transferred. Although examples are provided that collect or gather and transfer eggs, the experimental studies described herein can be conducted with many samples such as a combinatorial bead, a particle, and many samples including at least one cell of an organism, such as a germ cell, an egg, a seed, an embryo, or an organ. Experiments can be performed on an empirical number of samples that are representative of samples transferred for use in studies, for example screening studies on samples such as eggs with a diameter within a range from about 1 to 2 mm. For example, the flow rate of the vacuum can be adjusted such that liquid is drawn through the openings at a rate that does not harm a majority of the samples that are drawn into contact with the openings. The angle and height of the bottom face of the wand head relative to the container can also be adjusted. The injection of compressed gas (e.g., compressed air) can also be adjusted such that the samples are not harmed during ejection. The above-described parameters are examples of parameters that can be optimized, and additional operating parameters can be established and/or optimized. The operating parameters can include the sphericity of the samples transferred. Substantially spherical samples (e.g., eggs) can have a ratio of major axis (long) axis to minor (short) axis within a range from about 1.0 to 1.2. Empirical studies can be conducted to determine operational parameters so as to allow the use of substantially non-spherical samples, for example based on flow rates, vacuum pressure, minimum diameter of retention channel, maximum diameter of retention channel, sample deformation and viability.

Although the below experimental design is described with respect to the transfer of eggs, a person having ordinary skill in the art can conduct similar studies to determine physical parameters (e.g., size of the transfer device, size of the openings) and operational parameters (e.g., fluid flow rates) based on the teachings described herein in order to configure the device to handle alternative samples. - Experiment #1: Zebrafish Embryo Generation

Zebrafish embryos were generated by natural pair-wise mating at an aquaculture facility operated by Phylonix, Inc. in Cambridge, Mass. Zebrafish embryos were maintained in fish water (5 g of INSTANT OCEAN Sea Salt, 3 grams CaSO₄, 25 liters of distilled water) at approximately 28° C. for approximately 4 to 6 hours before sorting for viability. Early-stage zebrafish receive nourishment from an attached yolk sac, and therefore no additional maintenance is required.

### Experiment #2: Thirty-Opening Wand Prototype Design

A prototype aquatic egg transfer device (hereinafter “wand”) was configured to successfully transfer eggs to a multi-well microplate. The prototype wand was configured to transfer 30 eggs into a single discrete receptacle. The wand includes a wand head having 30 opening to retain eggs. The prototype wand can be configured with two buttons as described above (e.g., a purge button to purge liquid from the wand head prior to releasing the eggs and an eject button to apply positive pressure to release the eggs into the multi-well plate). The wand can be placed into a container containing zebrafish eggs dispersed in water. The zebrafish eggs are more dense than water and will rest on the bottom of the container. Application of a vacuum, provided by a venturi, to the wand will draw water into the openings and thereby draw eggs into contact with the openings (one egg per opening). Each opening of the wand was designed to retain one egg. The collecting or gathering process can continue until all of the 30 openings are filled. The wand can be configured such that only a minimum amount of the collected water is released from the wand with each egg released. As described above, compressed air was used in conjunction with a venturi to generate the vacuum used to collect or gather the eggs and to provide the positive pressure to release the eggs from the wand head. Some of the variables that can be adjusted include: a) the vacuum level used to collect or gather the eggs, b) the configuration of the retention channels and openings along the bottom face of the wand head, c) pressure and time necessary to release the eggs from the wand, and d) the wand system design. As discussed below in reference to Examples 3 through 5, tests were performed to determine optimum parameters for the collecting or gathering of eggs, measure the accuracy of egg release, and measure the viability of the transferred eggs.

The wand was operated according to the following procedure: (1) turn on in house air supply to the venturi; (2) turn on power supply to the vacuum pressure provided by the venturi to the gas outlet; (3) assess if the wand can effectively withdraw water; (4) place the wand into the collection vessel and begin drawing water and eggs into the openings by slowing moving the wand in a circular motion for approximately 10 to 15 seconds until the vacuum pressure stabilizes at a final vacuum pressure; (5) remove the wand from the collection vessel and inspect the wand head under light to check for 100% opening occupancy; (6) Repeat steps 4 and 5 if opening occupancy is less than 100%; (7) remove the wand head from the collection vessel and inspect the wand head under light to check for egg clumping (i.e., more than one egg collected at a given opening); (8) wash off any clumps by squirting fish water with a pipette or gently shaking the wand in the wash container; (9) remove excess liquid from the wand head by pressing the “purge” button until pressure stabilizes; (10) re-inspect openings according to step (5) to ensure that eggs remained attached during step (9); (11) place wand into 6-well microplate and dispense all thirty eggs into a single well of the 6-well microplate by pressing the “release” button for 2 to 5 seconds.

### Experiment Vacuum Pressure and Time for Collecting or Gathering Eggs

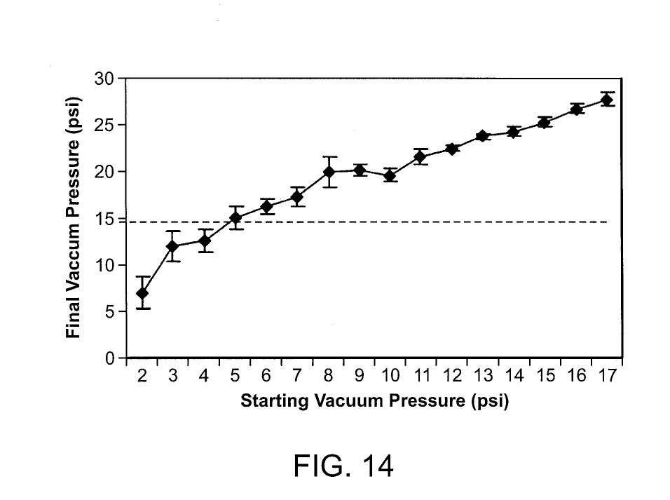

Using the eggs of Experiment #1 and the wand of Experiment #2, conditions can be determined for efficient collection of eggs that come into contact with the openings of the wand in the least amount of time that would be detrimental to eggs. In order to determine the optimum vacuum pressure, a pressure gage on the pressure controller was used. The vacuum was turned on and the starting vacuum pressure (SVP) of the unoccupied wand was set manually. Next, the wand head was placed in the collection vessel containing eggs. After one minute, the final vacuum pressure (FVP) was measured. The starting vacuum pressure was initially set to 2 psi and increased in 1 psi increments to a maximum starting vacuum pressure of 17 psi. As illustrated in FIG. 14, the final vacuum pressure is higher than the starting vacuum pressure for each measurement recorded for each starting vacuum pressure between 2 and 17 psi. In addition, higher starting vacuum pressures have associated higher final vacuum pressures.

In addition, the vacuum pressure can be varied so as to determine the minimum vacuum pressure necessary to draw the eggs into contact with the openings at an acceptable rate. For example, the minimum vacuum pressure necessary to bring 30 eggs into contact with the openings (100% occupancy) in 1 minute can be determined. The results of this test are shown in Table 1.

TABLE 1
Occupancy of wand openings as a function of vacuum pressure

| | | | Number of | |
|---|---|---|---|---|
| Number | | | Embyos in | Percent |
| of Trials | SVP (psi) | FVP (psi) | Openings | Occupancy |
| 1 | 2.5 | 9 | 0 | 0% |
| 3 | 3 | 10-12 | 0-30 | 0-100% |
| 4 | 3.5 | 13 | 29-30 | 96.7-100% |
| 22 | 4 | 12-15 | 27-30 | 90.0-100% |
| 9 | 5 | 14.5-17 | 30 | 100% |
| 1 | 7 | 17 | 30 | 100% |

The time required to collect and dispense the eggs of Experiment #1 using the wand of Experiment #2 with a starting vacuum pressure of 5 psi was also determined. The egg container was filled with 300 eggs. Two intervals of elapsed time were recorded: (1) the time the wand is immersed in the water of the collection vessel in order to achieve 100% occupancy of the openings (e.g., the time between immersing the wand into the collection vessel and removing the wand from the collection vessel); and (2) the time the wand is exposed to the air after collection in order to dispense the eggs (e.g., the time between removing the wand from the collection vessel and dispensing the eggs into a microplate well). Thus, the total elapsed time required to collect and dispense 30 eggs is the sum of the two time intervals described above. In 14 trials, the average time to collect the eggs (interval #1) was 10 seconds±5 seconds. The average time to dispense the eggs (interval #2) was 8 seconds±3 seconds. Thus, the total time to collect and dispense 30 eggs was 18±8 seconds. During most of the time, the eggs were exposed to a vacuum pressure between 5 and 15 psi. The eggs were briefly exposed to 6 psi of positive air pressure to dispense the eggs from the wand.

The vacuum pressure can also be varied to determine the maximum vacuum pressure that can be used without damaging a significant number of the eggs. A specific vacuum level can be maintained with a regulator to apply the same level of vacuum regardless of whether one or all of the openings are filled. This has the advantage of presenting the same level of (low) vacuum to all the eggs, which may be helpful to prevent egg damage. The optimum vacuum pressure can thereafter be selected based on a suitable trade-off between the rate of egg collecting or gathering and the level/percentage of egg damage. The vacuum pressure can be varied in combination with variations in the configuration of the retention channels and openings.

A series of tests can be used to determine the maximum level of vacuum that can be applied to an egg without damage. In this series of tests, a range of vacuum levels can be assessed along with duration of time under vacuum, which may be another critical factor. This can be used to define some vacuum operating pressure constraints for the collection device. Higher vacuum levels may facilitate faster and more efficient capture of the egg into contact with the retention structure. There may be a tradeoff, however, since higher pressures may increase the risk of egg damage. The effects of both the absolute vacuum level and total time exposure of an egg to that level of vacuum can be examined. Total time of vacuum exposure at specific vacuum levels may be an important factor in egg viability. The total time of vacuum exposure can be the elapsed time from the capture of the first egg to the release of the eggs into the assay plate.

In some embodiments, changes in vacuum pressure induced by the filling of the openings may not be significant enough to reliably indicate when the openings are filled with eggs (e.g., especially when the device incorporates an aspirate flow control mechanism). As such, other means of monitoring the filling of the openings can be used if necessary. For example, visual monitoring of the openings can be used. Additionally, in some embodiments, the flow rate through each retention channel is monitored via a flow sensor as described above and can be used to indicate the presence of an egg retained in the associated opening of the retention channel.

Different species or eggs or other samples collected are expected to have different densities. Therefore, similar experiments can be performed to determine the optimal pressure for the particular application.

### Experiment #4: Optimum Pressure for Dispensing Eggs

The reliability of releasing captured eggs from the wand head into discrete receptacles of a multi-well plate was also assessed. During prototype testing, the rate at which eggs stick to the retention structure instead of being released was evaluated. To some extent, the egg sticking rate may be influenced by factors such as the retention structure material (i.e., the bottom face of the wand head), the configuration of the openings on the bottom face of the wand head, the vacuum level used to capture the egg, the surface tension of the water, the quantity of liquid retained in each retention channel, and the duration of time the eggs are captured. The pressure applied to release the eggs into the wells of the multi-well plate can be independently varied and evaluated as a practical means of facilitating and optimizing egg release, while continuing to evaluate different materials for the retention structure and opening configurations. Additionally, the amount of water released with each egg can be evaluated and the configuration of the retention channels varied to vary the amount of water released.

Thirty eggs according to Experiment #1 were collected using the wand of Experiment #2. The presence of 30 eggs in the openings of the wand head can be verified visually or with sensors on each retention channel, as described above. Following verification that 30 eggs have been retained, the wand was shaken lightly to remove excess external water present on the wand head. Next, excess internal water in the manifold channel system was purged by pressing the “purge” button to allow air to “backfill” the manifold channels so as to prevent the release of excess fluid into the multi-well plate upon release of the eggs. The eggs were then released by applying positive air pressure into the manifold chamber by pressing the “release button,” as described above. Following egg release, the number of eggs present in the multi-well plate was counted and plotted against the value of positive air pressure used to eject the eggs. Table 2 shows the results of ejection efficiency trials conducted at varying applied air pressures. Ten trials were conducted with a wand head having 30 openings for a total of 300 eggs collected. The number of eggs dispensed (and hence the ejection efficiency) were determined by counting the eggs in the multi-well plate upon ejection.

TABLE 2
Assessment of Ejection Pressure

| Ejection | Total Number of | |
|---|---|---|
| Pressure | Embryos Dispensed | |
| (psi) | (10 trials) | Ejection Efficiency |
| 4 | 299 | 99.70% |
| 5 | 300 | 100% |
| 6 | 300 | 100% |
| 7 | 300 | 100% |
| 8 | 300 | 100% |

Although 100 percent release efficiency was achieved, lower ejection pressure is desirable, and therefore additional factors that can be optimized independently can include the retention structure material (i.e., the bottom face of the wand head), the configuration of the openings on the bottom face of the wand head, the vacuum level used to capture the egg, the surface tension of the water, the quantity of liquid retained in each retention channel, and the duration of time the eggs are captured.

In addition, the amount of residual water dispensed into a well plate was also measured. For example, the eggs can be dispensed into the wells of a multi-well plate containing, for example, 3 ml of water. The amount of residual water released can be important because changes in water volume in the wells of the multi-well plate can affect the concentration of a test substance added to the wells. Therefore, a small and consistent amount of residual water is desirable. Due to water surface tension, an amount of water may cling to the exposed surface of each egg while the egg is retained in contact with the retention structure, and thereby may impact the concentration of the test substance.

Eggs were collecting using a starting vacuum pressure of 5 psi. Water was then purged by pressing the “purge” button. Next, the eggs were released into an empty microplate using an ejection pressure of 6 psi by pressing the “release” button. The total residual water volume (TRWV) of water released from the wand head having 30 eggs was measured by drawing the water surrounding all 30 eggs into a pipette tip (PIPETMAN P200). The mean TRWV measured over ten experiments was 40 L±9 μL for all 30 eggs. The calculated mean residual value for each individual egg was 1.33 μL (i.e., 40 μL/30 eggs).

### Experiment #5: Embryo Viability and Morphology

The viability and morphology of dispensed eggs was also assessed. Many factors, including vacuum and ejection pressures, retention channel and opening configurations, and water and air exposure time duration, can affect the viability of the eggs transferred. To assess the impact of the transfer on egg viability, it is preferable to use only viable eggs during the testing. For example, at least about 400 viable eggs can be isolated from 4-6 hours post-fertilization (hpf) eggs based on the morphology of the egg and the yolk sac with known methods. A person of ordinary skill in the art can select eggs with an even dome of cells that is adherent to the yolk, and the yolk should be also be uniform without obvious blemishes. Experiments can be discarded and repeated if too much lethality and malformation is observed in control batches (i.e., picking up eggs manually with known slow methods, such as the Pasteur pipette).

Viable embryos prepared according to Example #1 were prepared and divided into two groups of at least about 300 embryos. In a first group of 300 embryos, 30 embryos were dispensed manually using a Pasteur pipette into a single well of a 6-well microplate containing 3 ml of water. In a second group of 300 embryos, 30 embryos were dispensed into a single well of a 6-well microplate containing 3 ml of water using the prototype wand of Experiment #2. In the second group, the embryos were collected using a starting vacuum pressure 5 psi and an ejection pressure of 6 psi. After dispensing the embryos, the number of embryos in each microplate well can be counted.

Thereafter, the number of viable embryos in each well can be counted at four days post-fertilization (dpf). Viability was determined using heart beat and touch response. The heart is first visible as a single straight tube that begins to beat at 24 hpf. Embryos with no heart beat were considered dead. Percent viability for manual (pipette) and wand collection and distribution was calculated according to the formula: Percent Viable=(Number of embryos at 4 dpf/30)×100%. Ten wells per experiment were assessed, and the experiment was performed three times. At 4 dpf, the percent viability was 97%±1% for the manual (pipette) technique and 96%±3% for the wand technique.

As the data shows, the viability of embryos transferred with the wand is comparable to known methods using a pipette. Although the viability of manually-dispensed embryos may theoretically reach 100%, this result may not be observed due to sources of error such as less than 100% accuracy in isolating viable eggs. The viability of wand dispensed eggs may also vary due to similar sources of error.

After assessing the viability of manual (pipette) and wand dispensed embryos, the morphology of the embryos was also assessed. Although the methodology is traditionally used to assess compound-induced teratogenicity, defects caused by wand processing were expected to exhibit similar morphological phenotypes. Overall morphology and morphology of the organs was inspected by light microscopy. Defects in the morphology of the body, eyes, heart, liver, and intestine were assessed, as well as edema and tissue degeneration. Table 3 shows the results of this test.

TABLE 3
Morphological Assessment of Transferred Embryos

| | Number of | Total | Percent |
|---|---|---|---|
| Collection | morphologically- | number of | morphologically- |
| technique | normal embryos | embryos | normal embryos |
| Manual (pipette) | 871 | 879 | 99.1% |
| Wand | 850 | 860 | 98.8% |

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

While this invention has been particularly shown and described with references to example embodiments thereof, it will be understood by those skilled in the art that various changes in form and details may be made therein without departing from the scope of the invention encompassed by the appended claims.

1-93. (canceled)

94. A handheld wand capable of removing a plurality of zebrafish or zebrafish eggs from a liquid and placing the zebrafish or zebrafish eggs into discrete receptacles of a holding fixture, comprising:
a wand head having a bottom face with a first array of openings suitable for holding zebrafish or zebrafish eggs, the first array suitable for immersion in a liquid and adapted for registration with a second array defined by the discrete receptacles of the holding fixture;
a gas outlet in fluid communication with the first array of openings, the gas outlet adapted for applying a negative gas pressure to the first array so as to be able to capture zebrafish or zebrafish eggs at the first array of openings;
a gas inlet in fluid communication with the first array, the gas inlet adapted for allowing gas to enter the first array so as to be able to release zebrafish or zebrafish eggs from the first array of openings;
a means for controlling the flow of gas through the gas outlet and gas inlet; and
a handle connected to the handheld wand.

95. The handheld wand of claim 94, wherein the handle is connected to the wand head by a neck member.

96. The handheld wand of claim 94, wherein the means for controlling the flow of gas through the gas outlet and gas inlet comprises a release button configured to control a release flow controller to permit gas to flow into the gas inlet.

97. The handheld wand of claim 94, further comprising a gas outlet channel that is smaller in cross-sectional area than the gas outlet.

98. The handheld wand of claim 94, further comprising a compressed gas source coupled to the gas inlet to provide a source of gas to release the zebrafish or zebrafish eggs.

99. The handheld wand of claim 98, further comprising a venturi coupled to the compressed gas source to provide the negative gas pressure to the gas outlet.

100. The handheld wand of claim 94, wherein the openings of the first array have a conically-shaped surface flaring outward.

101. The handheld wand of claim 94, wherein the first array of openings are in fluid communication with the gas outlet and gas inlet via a plurality of manifold channels.

102. The handheld wand of claim 94, wherein the first array of openings are in fluid communication with the gas outlet and gas inlet via a plurality of retention channels.

103. The handheld wand of claim 94, wherein the wand head has two manifolds.

104. The handheld wand of claim 94, wherein the wand head has four manifolds.

105. A method of removing a plurality of zebrafish or zebrafish eggs from a liquid and placing the zebrafish or zebrafish eggs into one or more discrete receptacles of a holding fixture, the method comprising:
contacting a wand head with the liquid, the wand head having a bottom face with a first array of openings suitable for holding the zebrafish or zebrafish eggs and adapted for registration with a second array defined by the discrete receptacles of a holding fixture;
drawing some of the liquid through the first array of openings by using negative pressure in order to capture and retain the zebrafish or zebrafish eggs in contact with the openings of the first array;
moving the first array or the holding fixture relative to the other while retaining the zebrafish or zebrafish eggs in contact with the first array of openings so as to bring the first array into registration with the second array; and
releasing the zebrafish or zebrafish eggs from the first array of openings and into the one or more discrete receptacles of the holding fixture.

106. The method of claim 105, further comprising releasing some of the liquid drawn through the first array of openings into the one or more discrete receptacles of a holding fixture.

107. The method of claim 105, wherein the zebrafish or zebrafish eggs are released so that each discrete receptacle of the holding fixture receives only one zebrafish or zebrafish eggs.

108. The method of claim 105, wherein the holding fixture is a multi-well plate.

109. The method of claim 105, further comprising increasing the pressure at the first array of openings to eject the zebrafish or zebrafish eggs from the first array of openings.

110. The method of claim 105, wherein the openings of the first array have a conically-shaped surface flaring outward.

111. The method of claim 105, wherein the liquid is drawn through each of the openings of the first array at a rate of about 1 mL/minute to about 20 mL/minute.

112. The method of claim 105, wherein the liquid is drawn through each of the openings of the first array at a rate of about 2 mL/minute to about 10 mL/minute.

113. The handheld wand of claim 105, wherein the wand head has two manifolds.

114. The handheld wand of claim 105, wherein the wand head has four manifolds.
